(19) United States
(12) Patent Application Publication
(10) Pub. No.: US 2011/0190153 A1
(43) Pub. Date: Aug. 4, 2011

(54) SYSTEM AND METHOD FOR HYBRIDIZATION SLIDE PROCESSING

(76) Inventors: Nils Adey, Salt Lake City, UT (US); Tom Moyer, Salt Lake City, UT (US); Rob Parry, Park City, UT (US); Dale Emery, Salt Lake City, UT (US)

(21) Appl. No.: 12/997,238

(22) PCT Filed: Jun. 9, 2009
(86) PCT No.: PCT/US09/46795

§ 371 Date: Mar. 18, 2011

Related U.S. Application Data
(63) Continuation-in-part of application No. 12/207,343, filed on Sep. 9, 2008.
(60) Provisional application No. 61/060,070, filed on Jun. 9, 2008.
(60) Provisional application No. 61/150,599, filed on Feb. 6, 2009.

(51) Int. Cl. C40B 30/04; C40B 60/12

(52) U.S. Cl. 506/9; 506/39

(57) ABSTRACT

A system 300 for the substantially-automated hybridization of a plurality of microarray slides. The system comprises an enclosure 310 with a wash basin 312 having an open top end, a lower carrier rotor 330 disposed within the wash basin on a support axle 318 for receiving a plurality of microarray slide substrates 362, and an upper clamp rotor 340 disposed above the lower carrier rotor on the support axle for receiving a plurality of disposable chamber assemblies 240. The system is further configured so that lowering the upper clamp rotor to engage with the lower carrier rotor couples the plurality of chamber assemblies to the plurality of slide substrates to form a plurality of sealed reaction chambers 244, and raising the upper clamp rotor to disengage from the lower carrier rotor de-couples the plurality of chamber assemblies from the plurality of slide substrates to unseal the plurality of reaction chambers.

### RELATED APPLICATIONS

This application claims the benefit of U.S. Provisional Patent Application No. 61/060,070, filed Jun. 9, 2008, and entitled, “System and Method for Hybridization Slide Processing,” U.S. patent application Ser. No. 12/207,343, filed Sep. 9, 2008 and entitled “System and Method for Hybridization Slide Processing,” and U.S. Provisional Patent Application No. 61/150,599, filed Feb. 6, 2009, and entitled, “System and Method for Hybridization Slide Processing,” each of which is incorporated by reference in its entirety herein.

### FIELD OF THE INVENTION

The field of the invention relates generally to the processing of hybridization slides for the analysis of immobilized DNA samples.

### BACKGROUND OF THE INVENTION AND RELATED ART

Hybridization slide processing and analysis, such as Fluorescent In Situ Hybridization (FISH), is a well known technique for detecting whether a specific nucleic acid resides in a given sample. This technique generally includes the immobilization of known nucleic acid sequence probes on a glass slide, followed by introduction of the sample media to the probes in order to determine whether the sample contains any complementary nucleic acid sequence. Fluorescent indicators can be attached to the sample media, so that the hybridized sample can later be queried or analyzed using a fluorescence microscope or similar slide reader. When matching sequences are found, a fluorescent indicator appears to confirm the match.

While hybridization slides are frequently used in analysis of DNA samples, they may also be used in diagnostic testing of other types of samples. Probe locations in microarrays may be formed of various large biomolecules, such as DNA, RNA, and proteins, smaller molecules such as drugs, co-factors, signaling molecules, peptides or oligonucleotides. While it is typical to immobilize known reactants on the substrate, expose an unknown liquid sample to the immobilized reactants, and query the reaction products in order to characterize the sample, it is also possible to immobilize one or more unknown samples on the substrate and expose them to a liquid containing one or more known reactants.

Processing a hybridization slide for later analysis typically can require a significant number of process steps, including forming a reaction chamber around the portion of the slide containing the array of immobilized reactant probes, filling the reaction chamber with the mobile reactant specimens in solution, hybridizing the specimens with the probes during an incubation step, and washing off the un-hybridized fluid sample from the microarray slide upon completion of the incubation phase, without damaging the hybridized reactant samples. While attempts have been made to mechanize one or more these steps, the automation of the complete hybridization process to date has produced mixed results in terms of the quality of the exposed microarray slides, or is prohibitively expensive. Many of these steps still require extensive manual activity to ensure that high-quality hybridized microarrays are made available for later analysis.

Each processing step can also require complex and specialized processing equipment and methods. For instance, it is often desirable that reactions performed on microarrays consume minimal quantities of hybridization sample fluid, due limited specimen availability. When small quantities of hybridization fluid are spread out over the area of the microarray, however, the fluid layer is very thin, leading to the possibility that, if no mixing is provided, the sample fluid will become locally depleted of a particular sequence over the spot binding that sequence. As target specimens are depleted, reaction kinetics can slow, resulting in a lower signal. This is a greater problem for low-abundance sequences. It is considered particularly desirable that hybridization be performed in a low-volume reaction chamber, with mixing. Low volumes allow for higher concentration of reactants that are in limited supply, while mixing maintains initial kinetic rate and thus produces more reaction products.

### SUMMARY OF THE INVENTION

In accordance with the invention as embodied and broadly described herein, the present invention includes a hybridization unit for providing a hybridization reaction chamber on a microarray slide. The hybridization unit includes a microarray slide substrate having a reaction area containing immobilized reactants. The slide substrate can be substantially rectangular with a pair of exposed parallel edges for attachment to a carrier fixture of a processing device. A disposable chamber assembly or “mixer” is removably coupled to the slide substrate to form a sealed low-volume reaction chamber enclosing the reaction area. The chamber assembly or mixer can be made from a plastic or polymeric material, and can be disposable. The hybridization unit further includes an attachment means for coupling the disposable chamber assembly to a clamp fixture of the processing device, such that separation of the clamp fixture from the carrier fixture removes the disposable chamber assembly from the slide substrate to open the sealed reaction chamber.

The disposable chamber assembly can further include a flexible base layer having top and bottom surfaces with the bottom surface forming a ceiling of the reaction chamber, a weakly-adhesive gasket seal extending downward from the bottom surface of the base layer to form sidewalls of the reaction chamber, and wherein the attachment means comprises a strongly-adhesive upper patch extending from the top surface of the base layer for attachment to the clamp fixture of the processing device.

The disposable chamber assembly can also be configured with borders that extend beyond one pair of parallel edges of the slide substrate, to allow the disposable chamber assembly to be coupled to an upper clamp fixture in a processing device. The slide substrate and the disposable chamber assembly are further configured to expose the other pair of parallel edges of the slide substrate, for coupling the slide substrate to a lower carrier fixture in the processing device.

The disposable chamber assembly or mixer can further include a manifold coupled to the exposed surface of the disposable chamber assembly having fill and vent holes aligned with the fill port and a vent port in the disposable chamber assembly.

In accordance with the invention as embodied and broadly described herein, the present invention further includes a system for the substantially-automated hybridization of a plurality of microarray slides. The system comprises a basin enclosure having an open top end, a lower carrier rotor disposed on a support axle within the basin enclosure for receiving a plurality of microarray slide substrates, and an upper clamp rotor disposed on the support axle and above the lower carrier rotor for receiving a plurality of disposable chamber assemblies or mixers. The system is configured so that lowering the clamp rotor to engage with the carrier rotor couples the plurality of chamber assemblies to the plurality of slide substrates to form a plurality of sealed reaction chambers. The system is further configured so that raising the upper clamp rotor to disengage from the lower carrier rotor de-couples the plurality of chamber assemblies from the plurality of slide substrates to unseal the plurality of reaction chambers.

The present invention also includes a method for processing a plurality of microarray slides, which method comprises the steps of inserting a plurality of microarray slides into a processing device, where each of the microarray slides has a reaction area covered by a low-volume reaction chamber assembly or mixer. The method continues with filling the reaction chambers with a low-volume of hybridization fluid to hybridizing the reaction area of each of the microarray slides. The method further includes the steps of removing the reaction chamber assemblies from each of the microarray slides to expose the hybridized reaction areas, washing the microarray slides in a common bath of wash fluid, removing the wash fluid from the microarray slides, and disengaging the microarray slides from the processing device.

The present invention also includes a method for the in-situ processing of a microarray slide for the analysis of immobilized samples. The method includes the steps of obtaining a slide substrate having a reaction area containing immobilized samples and mounting the slide substrate into a processing device for automated in-situ processing. The in-situ processing further comprises the steps of coupling a disposable chamber assembly or mixer to the slide substrate to form a low-volume reaction chamber enclosing the reaction area, filling the reaction chamber with hybridization fluid to react with the immobilized samples, sealing the reaction chamber to prevent contamination during incubation, de-coupling the mixer from the slide substrate to open the low-volume reaction chamber and expose the reaction area, flushing the reaction area with a high volume of wash fluid to remove the hybridization fluid, and removing the wash fluid from the slide substrate.

Other aspects of the method of the present invention can include agitating the hybridization fluid within the reaction chamber to increase the reaction with the immobilized samples on the microarray slide, and sealing the reaction chamber by removably plugging the fill and vent holes in the mixer/manifold assembly with a plurality of valve pins.

The present invention also includes a method for post-processing the hybridized slide that has been flushed with wash fluid to remove the hybridization fluid. The method can includes the steps of re-attaching the disposable chamber assembly or mixer to the slide substrate to re-form the low-volume reaction chamber enclosing the hybridized reaction area, and performing a variety of fluidic steps such as nucleic acid denaturation and recovery on the hybridized and washed microarray slides.

In another aspect of the invention, instead of de-coupling the mixer from the slide substrate and flushing the reaction area with a high volume of wash liquid, an elution buffer is slowly pumped into the reaction chambers to wash the reaction areas and displace the original sample of hybridization fluid, which is pushed out and collected with an appropriate collection device positioned below the slide substrate. The reaction chamber is then re-sealed and re-heated for a second processing step, after which additional elution buffer is pumped through the reaction chambers to force the reacted fluid into another collection device for additional analysis.

### BRIEF DESCRIPTION OF THE DRAWINGS

Features and advantages of the invention will be apparent from the detailed description that follows, and which taken in conjunction with the accompanying drawings, together illustrate features of the invention. It is understood that these drawings merely depict exemplary embodiments of the present invention and are not, therefore, to be considered limiting of its scope. And furthermore, it will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings, in which:

FIG. 1A illustrates a top view of a disposable reaction chamber assembly for forming a sealed reaction chamber about a reaction area containing immobilized reactants, according to an exemplary embodiment of the present invention;

FIG. 1B illustrates a sectional side view of the disposable reaction chamber assembly of FIG. 1A, taken along section line A-A;

FIG. 1C illustrates a plurality of the disposable reaction chamber assemblies of FIG. 1A mounted on a strip;

FIG. 2A illustrates a sectional side view of another exemplary embodiment of a disposable reaction chamber assembly;

FIG. 2B illustrates a sectional side view of another exemplary embodiment of a disposable reaction chamber assembly;

FIG. 3A illustrates a sectional side view of another exemplary embodiment of a disposable reaction chamber assembly;

FIG. 3B illustrates a sectional side view of another exemplary embodiment of a disposable reaction chamber assembly;

FIG. 4 illustrates a method of forming a sealed reaction chamber on a hybridization slide and subsequently filling the chamber with a low-volume of hybe solution, in accordance with an exemplary embodiment of the present invention;

FIG. 5 illustrates a method of applying a low-volume of hybe solution and subsequently forming a sealed reaction chamber on a hybridization slide, in accordance with another exemplary embodiment of the present invention;

FIG. 6 illustrates a system for the semi-automated hybridization of a plurality of hybridization slides, in accordance with an exemplary embodiment of the present invention;

FIG. 7 illustrates a method of installing a plurality of hybridization slides into the hybridization system of FIG. 6;

FIG. 8 illustrates a method of applying a low-volume of hybe solution and forming a sealed reaction chamber on a plurality of hybridization slides installed into the hybridization system of FIG. 6;

FIG. 9 illustrates a method of assembling the hybridization system of FIG. 6 prior to performing a hybridization protocol;

FIGS. 10A-10D together illustrate a method of processing a plurality of hybridization slides with the hybridization system of FIG. 4 and in accordance with an exemplary embodiment of the present invention; and

FIG. 11A illustrates a top view of a hybridization unit, according to an exemplary embodiment of the present invention;

FIG. 11B illustrates a sectional side view of the hybridization unit of FIG. 1, taken along section line B-B;

FIG. 12 illustrates a perspective view a system for the automated hybridization of a plurality of hybridization slides, in accordance with another exemplary embodiment of the present invention;

FIG. 13 illustrates a top view of the hybridization system of FIG. 12;

FIG. 14 illustrates a sectional side view of the hybridization system of FIG. 12;

FIG. 15 illustrates an exploded view of the hybridization system of FIG. 12;

FIG. 16A illustrates a sectional side view of the rotors in an engaged position;

FIG. 16B illustrates a sectional end view of the rotors in an engaged position;

FIG. 17A illustrates a sectional side view of the rotors after lifting the upper rotor to separate the mixer and the slide substrate;

FIG. 17B illustrates a sectional end view of the rotors after lifting the upper rotor to separate the mixer and the slide substrate;

FIG. 18A illustrates a sectional side view of the rotors in the wash position;

FIG. 18B illustrates a sectional end view of the rotors in the wash position;

FIG. 19 illustrates a perspective view of an automated hybridization system, according to another exemplary embodiment of the present invention;

FIG. 20 illustrates an exploded view of the hybridization system of FIG. 19;

FIG. 21 illustrates an exploded, perspective view of a hybridization system, according to yet another exemplary embodiment of the present invention;

FIG. 22 illustrates a detailed view of one aspect of the hybridization system of FIG. 21;

FIG. 23 illustrates a method of installing a plurality of hybridization units into the hybridization system of FIG. 6, in accordance with another exemplary embodiment of the present invention;

FIG. 24 illustrates a method of assembling the hybridization system of FIG. 23 prior to performing a hybridization protocol;

FIGS. 25A-25D together illustrate a method of processing a plurality of hybridization slides with the hybridization system of FIGS. 23-24; and

FIG. 26 illustrates a hybridization step of method of mixing a plurality of hybridization slides installed into the hybridization system using gravity-induced bubble mixing, in accordance with another exemplary embodiment of the present invention

### DETAILED DESCRIPTION OF EXEMPLARY EMBODIMENTS

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

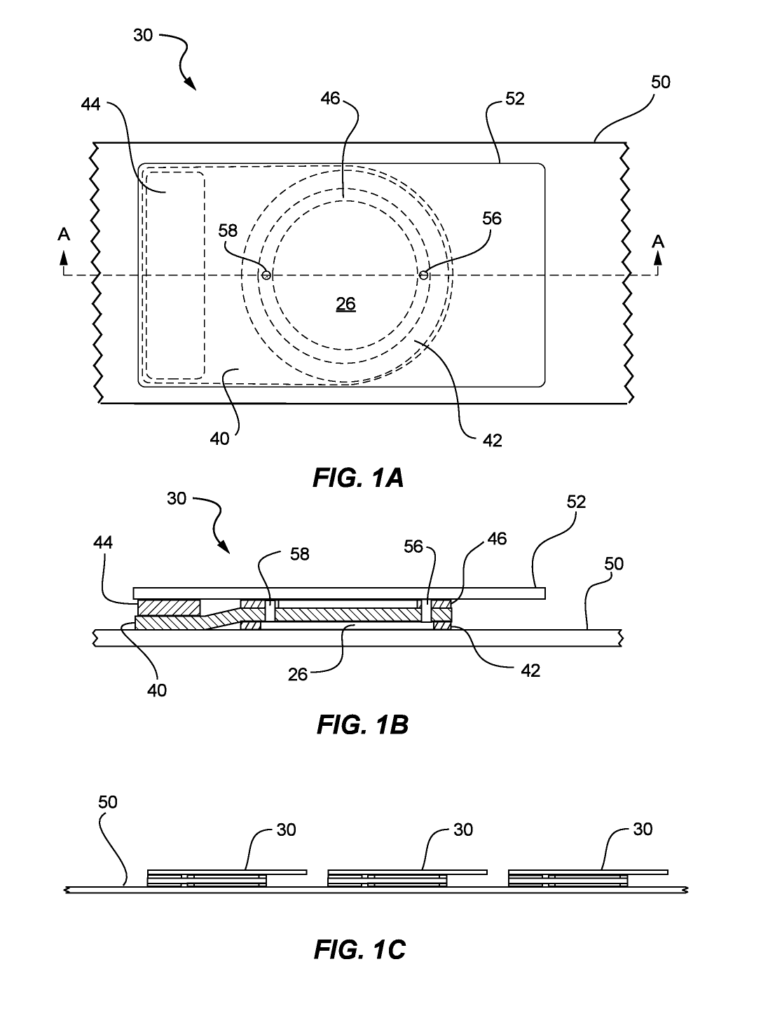

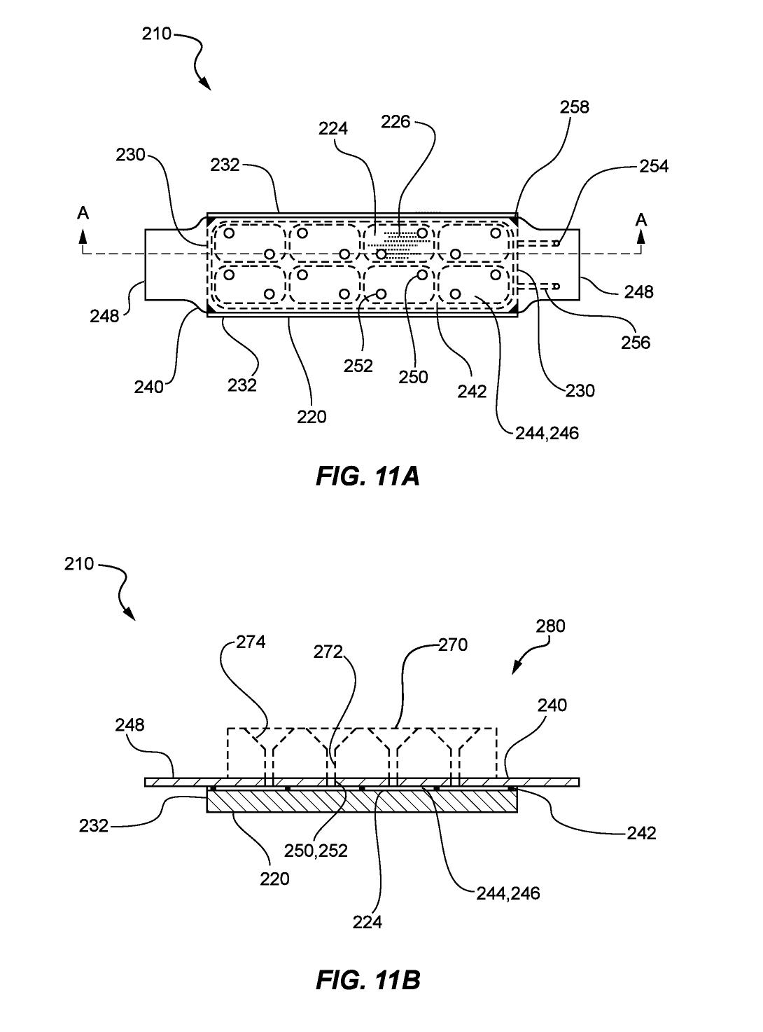

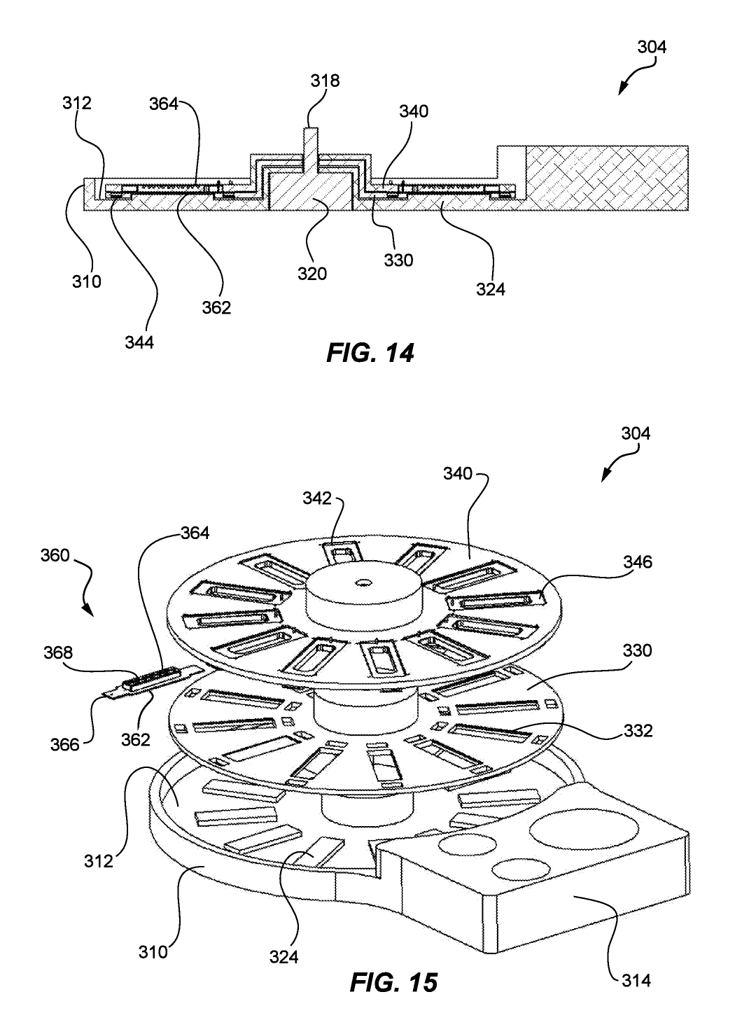

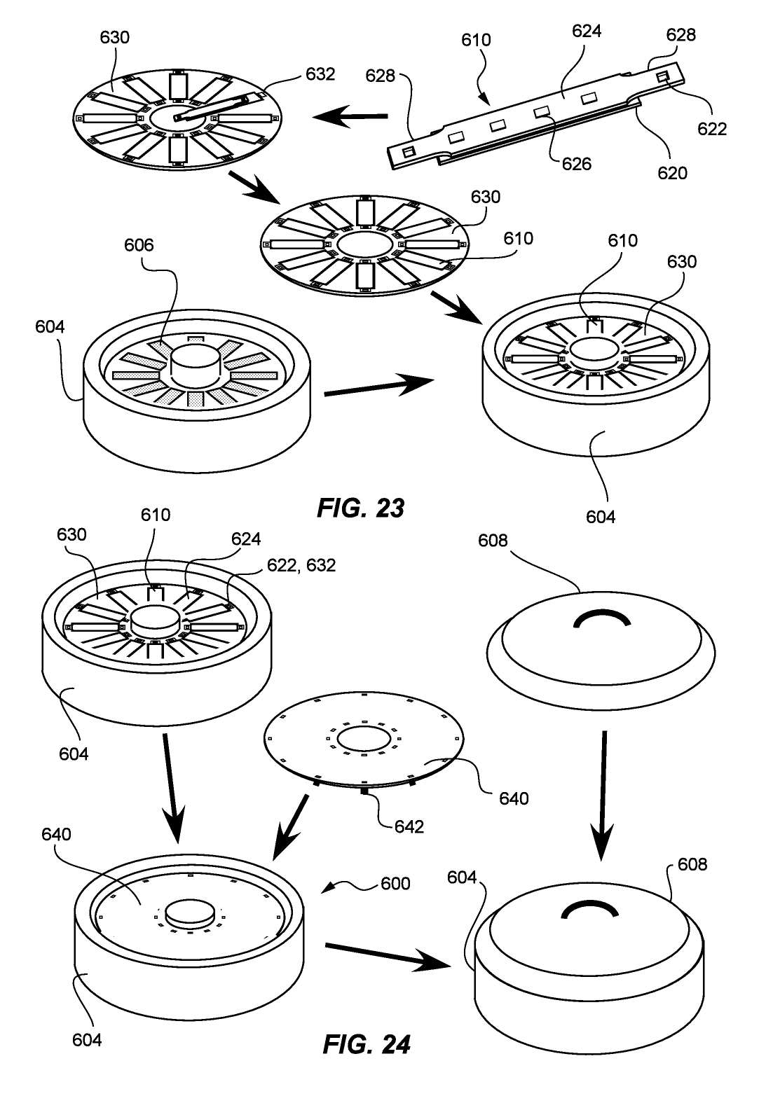

It has been recognized by the present inventors that it would be advantageous to follow the hybridization step of the hybridization process with a wash step that is much higher in fluid volume than the fluid volume used in hybridization. It has also been recognized by the present inventors that it can be advantageous, in certain circumstances, to precede the hybridization process with a high volume wash step, to clean and prepare the hybridization slides prior to hybridization. Illustrated in FIGS. 1-10, therefore, are various exemplary embodiments of a semi-automated hybridization slide processing system and method can include a high-volume pre-hybridization wash step, a low-volume hybridization step and a high-volume post-hybridization wash step. Alternatively, illustrated in FIGS. 11-22 are various exemplary embodiments of a substantially-automated hybridization slide processing system and method that can include a low-volume hybridization step and a high-volume post-hybridization wash step. Shown in FIG. 23 is an exemplary hybridization system and method for mixing a plurality of low-volume hybridization slides using gravity-induced bubble mixing, which hybridization step could be included in either of the semi-automated or substantially-automated slide processing systems.

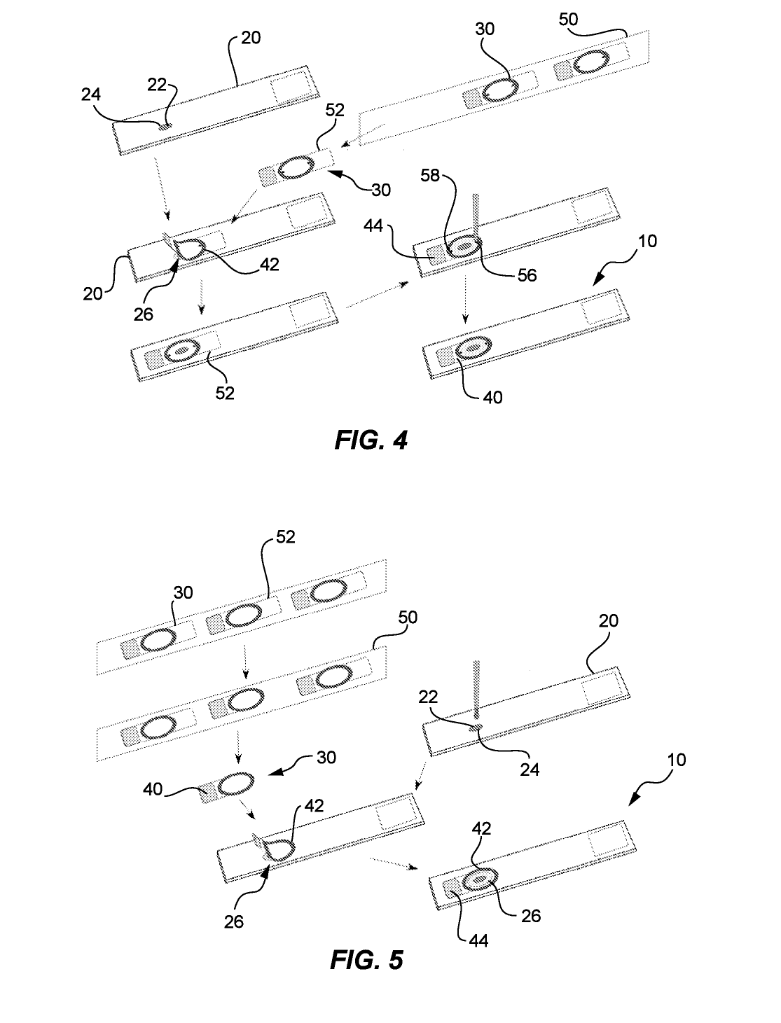

The hybridization system of the present invention can include various exemplary embodiments of a hybridization unit having a disposable reaction chamber assembly 30, some of which assemblies are shown with more particularity in FIGS. 1-3. Referring briefly to FIG. 4 and FIG. 5, a hybridization unit 10 can comprise a substantially rectangular glass slide substrate 20 having a sample or reaction area 22 that contains immobilized reactants 24, such as immobilized DNA samples and tissue sections. The reaction area can be covered by a disposable reaction chamber assembly 30 that is removably coupled to the slide substrate 20 to form a low-volume reaction chamber 26 that encloses the reaction area 22 and that can contain the hybridization (“hybe”) solution during processing. The rectangular glass slide substrate 20 coupled with the chamber assembly 30 can together form a hybridization unit 10.

Referring back to FIGS. 1A-1B, in one aspect the chamber assembly 30 can include a flexible base layer 40 having a seal gasket 42 extending downwards from the bottom surface of the base layer, with the bottom surface of the base layer forming the ceiling to the low-volume reaction chamber 26 and the thickness of the seal gasket itself forming the sidewalls of the reaction chamber. As shown the gasket seal 42 can be annular or ring-shaped; however, other shapes including ellipses, polygons or other irregular shapes are also contemplated and can be considered to fall within the scope of the present invention. The seal gasket 42 can be a removable adhesive gasket, an elastomeric seal (such as an O-ring or a gasket, including a silicone gasket) or any other sealing mechanism available in the art that is sufficient to form a sealed reaction chamber capable of holding and containing the hybe solution during the filling and incubation stages of the process. The base layer 40 can have a rectangular shape with a rounded end, with the rounded end sized to and aligned with the seal gasket 42 to facilitate attached to the slide substrate. As shown, representative chamber assembly 30 can also include a fill port 56 and a vent port 58 to allow for the introduction of hybridization fluid, or hybe solution, into one end of the reaction chamber 26, and the venting of enclosed air or gases from the other end as it is filled with hybe solution.

The squared end of the flexible base layer 40 can extend laterally away from the reaction chamber 26 to form a tab, to which can be mounted an upper adhesive patch 44 that extends upwards from the top surface of the base layer. The chamber assembly 30 can further include an upper pressure gasket 46 that also extends upwardly from the top surface of the base layer 40 and which can be substantially aligned with the seal gasket 42 extending from the bottom surface. As will be discussed in greater detail below, the pressure gasket 46 can operate to evenly transfer sealing pressure provided an upper clamping fixture or rotor downward to the interface between the seal gasket 42 and slide substrate, to further seal the reaction chamber during a hybridization protocol.

An upper release liner strip 52 can be placed over the top surfaces of the adhesive patch 44 and the annular pressure ring 46 and, together with the lower release liner strip 50, can function to protect and seal the chamber assembly from outside contamination during storage and transport. A plurality of the disposable reaction chamber assemblies 30 can be mounted a single release liner strip 50 after manufacturing for ease of storage, transportation and use. (see FIG. 3).

The base layer 40 can be formed as a semi-flexible structure that is rigid enough to retain its shape, support handling of the chamber assembly, and provide an impervious ceiling for the reaction chamber 26, while remaining flexible enough to bend and peel away from the slide substrate. In one aspect, the base layer 40 can be a flexible plastic laminate having a prime coating on the bottom surface, and the seal gasket 42 can be an adhesive gasket. The prime coating surface can be oriented to form the inner surface of the reaction chamber, and also is the surface to which the adhesive gasket adheres. The adhesive gasket can adhere and bind more strongly to the prime coated surface than to the slide, making it possible to remove the disposable chamber assembly cleanly from the slide. These materials are preferred for use in devices used for performing hybridizations at about 37° C., with excursions up to about 90° C., and it will be appreciated that for reactions performed under other conditions, other materials may be more desirable. Accordingly, other plastics or polymeric materials may be used in construction of the device, with physical and chemical properties selected for the particular reaction conditions. All materials can be compatible with any chemicals or reactants that they contact, and not be deteriorated by such contact, nor interfere with the chemical reactions performed within the device.

The adhesive gasket of the present invention can be formed on the bottom surface of the base layer 40, and can be capable of creating a gas tight seal around the reaction chamber 26 with sufficient compressibility to create the desired chamber volume. It is important that when the chamber assembly is removed from the slide substrate, the seal gasket remains adhered to the base layer and not the slide, since gasket material remaining on the slide could interfere with the slide reader. The adhesive gasket must thus adhere preferentially to the base layer, with its prime coating, rather than the slide substrate. A variety of removable and repositionable adhesives may be used, including, but not limited to, acrylic, urethane, silicone, and rubber adhesives. Such materials are resilient and subject to plastic and/or elastic deformation. The adhesive gasket may be formed from a commercially available adhesive film, or may alternatively be applied by spray coating, silk screening, pad printing or other printing method that produces a suitable finish and thickness.

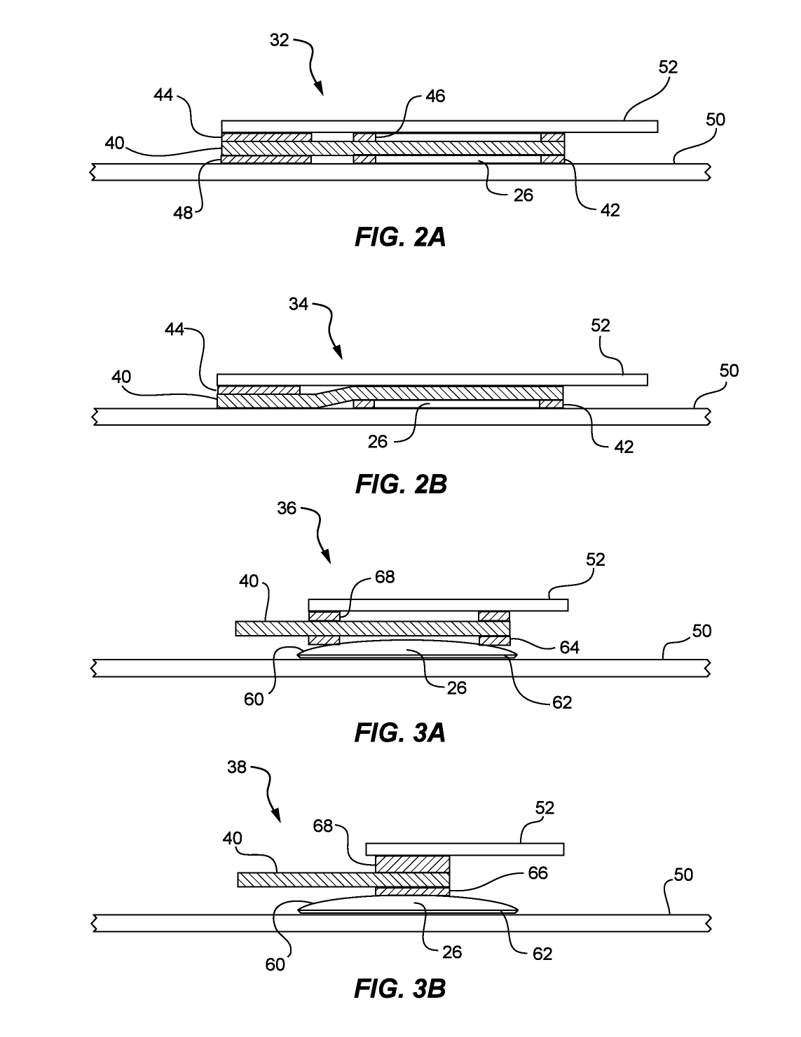

Additional embodiments of the disposable chamber assembly 32-34 are shown in more detail in FIGS. 2A-2B. For instance, disposable chamber assembly 32 can be very similar to chamber assembly 30, with the exception that an additional strip 48 of silicone sheet material can placed under the tab portion of the base layer and the thickness of the upper adhesive patch 44 reduced to maintain the base layer in a generally horizontal position across its length. Chamber assembly 34 is also similar to the previous chamber assembly embodiments with the exception that the upper pressure gasket 46 is removed and the thickness of the upper adhesive patch 44 reduced to allow the upper release liner 52 to lay flush against the top surface of the base layer 40 that overlies the reaction chamber 26. Chamber assemblies 30, 32 and 34 may or may not include the fill and vent ports.

As stated above, the seal gasket 42 used with embodiments 30, 32 and 34 can have a different adhesivity than the adhesive patch 44. The seal gasket 42 can be mildly adhesive or non-adhesive, so that when the base layer is lifted at the appropriate time (e.g., after hybridization) the seal gasket 42 will release from the slide substrate and open the reaction chamber to expose the hybridized contents to the adjacent surroundings. In contrast, the adhesive patch 44 can be strongly adhesive in order to provided attachment between the tab portion of the base layer and the upper clamp rotor or fixture. As will be described hereinafter, lifting the upper clamp rotor can pull the tab portion of the base layer upward to sequentially peel the chamber assembly, including the seal gasket 42, off and away from the slide substrate.

Referring now to the disposable chamber assembly embodiments 36 and 38 illustrated in FIGS. 3A and 3B, the seal gasket can be replaced with a domed chamber 60 (or “contact lens”) that can be formed from a moldable silicon or similar material that allows for moderate deflection of the lower lip 62 under pressure to seal the reaction chamber 26 against the slide substrate during hybridization. The domed chamber 60 can be coupled to the base layer 40 with an annular 64 or circular 66 lower adhesive patch that is strongly adhesive, given that the lower lip 62 of the domed chamber 60 provides the sealing surface between the chamber and the slide substrate. Furthermore, with the domed chamber embodiments the strongly adhesive patch upper 68 can also be annular or circular, and can be positioned directly over the reaction chamber 26, as the domed chamber 60 can be lifted directly upwards to break the pressure seal formed between the lower lip and the slide substrate.

The placement of a representative disposable reaction chamber 30 over the sample or reaction area 22 and the application of the hybe solution are illustrated in FIGS. 4 and 5. As can be seen, the reaction area 22 containing the immobilized reactants 24 can cover only a small portion of the slide substrate 20, and the disposable chamber assembly 30 can be sized according. While it is anticipated that often just one reaction area may be formed on each slide substrate, it is possible for multiple reaction areas and multiple disposable chamber assemblies 30 to be used on a single slide.

The disposable chamber assemblies 30 can be supplied on a release liner strip 50. In the method illustrated in FIG. 4, the chamber assembly 30 can first be removed from the release liner and placed over the reaction area 22. The chamber assembly can be “brayed”, or pressed into the slide substrate 20 with a firm object, to better adhere the gasket seal 42 to the surface of slide substrate, and upper release liner strip 52 removed to expose the fill 56 and vent 58 ports and strong adhesive patch 44. Hybridization (“hybe”) or probe solution can then be introduced into the low-volume reaction chamber 26 with a pipette inserted into the fill port 56 formed in the base layer 40 at one end of the chamber assembly, while enclosed air or gases can be released through the vent port 58 formed at the opposite end. In one aspect, the fill and vent ports of the reaction chamber 26 can be sealed when the upper fixture or rotor is lowered onto the top surface of the base layer. Alternatively, the fill and vent ports of the reaction chamber 26 be sealed with the placement of small patches of tape over the top of the base layer before hybridization.

The method shown in FIG. 5 differs from that illustrated in FIG. 4 in that the hybe (or probe) solution is applied to the reaction area 22 prior to placement of the disposable chamber assembly 30 onto the slide substrate 22. In this embodiment the fill and vent ports are not formed into the base layer with the attendant concerns relating to the sealing of the reaction chamber 26, since the formation of the reaction chamber is complete with the attachment of the chamber assembly 30 to the slide substrate 20. However, additional care may be required to ensure placement of the chamber assembly about the applied portion of hybe solution and in a manner that minimizes the amount of air or gas trapped within the reaction chamber 26.

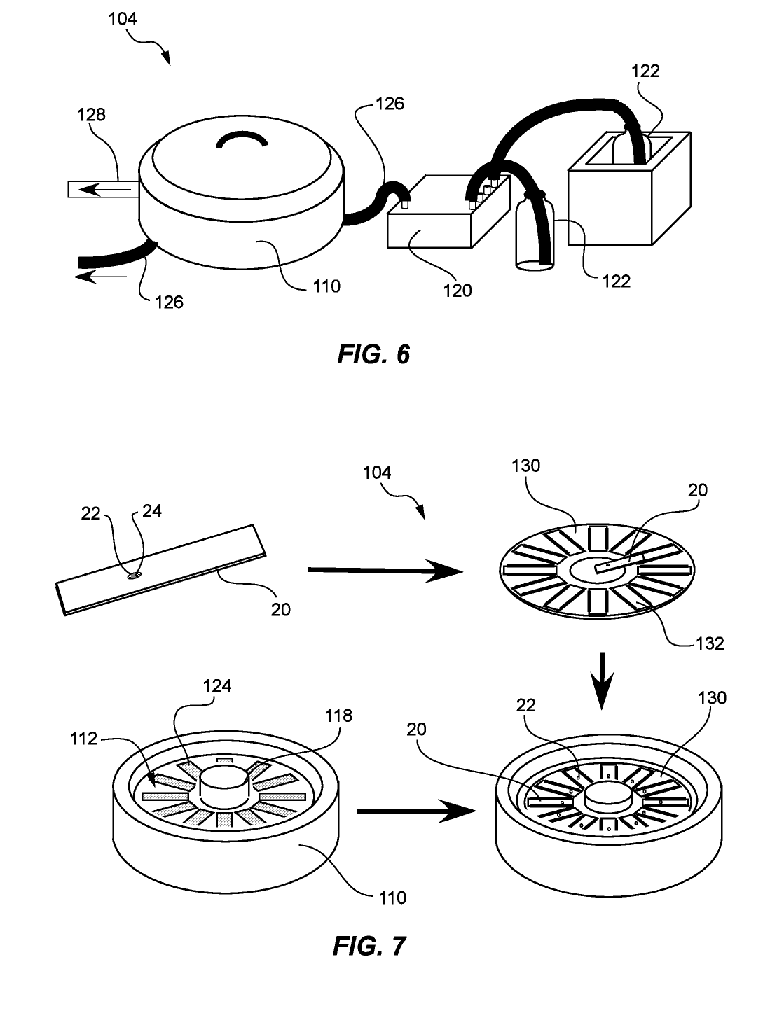

Illustrated in FIG. 6 is a processing device 104 for the semi-automated hybridization of a plurality of hybridization slides. The processing device 104 can include a basin enclosure 110 having an open top end. The basin enclosure can include an interior basin that is configured to hold a quantity of wash fluid for washing the hybridization slides after completion of the hybridization process. The basin enclosure can be circular, as illustrated, or can have any other shape or configuration capable of temporarily holding or containing a quantity of wash fluid sufficient to immerse or submerge the plurality of hybridization slides, which range can include, but is not limited to 0.1 to 3.0 liters of wash fluid.

The basin enclosure 110 can be fluidly coupled to a controllable pump/valve unit 120 that is capable of selection from a variety of fluid sources 122, such as containers or bottles of ethanol or similar fluid for pre-hybridization washing, and containers of wash buffer fluids for post-hybridization washing. The fluid sources 122 can be stored at ambient temperature, or maintained at a prescribed temperature inside a heated water bath, etc. The basin enclosure 110 can also include internal plumbing such as valves (not shown) and piping or tubing 126 for filling and/or draining the wash fluid from the basin, as well as an exhaust vent 128 for the controlled release of vapors or fumes.

As shown in FIG. 7, the processing device 104 can include a slide carrier disposed within the basin enclosure 110, and which is configured to receive a plurality of hybridization slide substrates 20 having one or more reaction areas 22. The slide carrier can be a lower carrier rotor 130 configured to be supported on a support axle 118 and driven by a spin motor (not shown) that allows rotational movement of the lower carrier rotor (including the received slide substrates) relative to the basin 112 and the wash fluid held therein. The lower carrier rotor 130 can also be configured for vertical movement up and down the rotational axis. The lower carrier rotor 130 and the basin enclosure 110 can be configured together for immersing the lower carrier rotor within a bath of wash fluid contained within the basin 112, followed by removing the lower carrier rotor from the bath and spinning to strip off any residual wash fluid.

The slide substrates 20 can be inserted into equally-spaced carrier rotor ‘windows’ 132 formed into the lower carrier rotor 130. The carrier rotor windows 132 can have slots or grooves formed into the inside surfaces for receiving and grasping the side and outer edges of the slide substrates. The slots can open towards the center portion of the carrier rotor and can be closed at the outer end, so that the slide substrates may be installed from the center of the rotor and secured to prevent the slides from slipping out of the window 132 during rotation, especially during high-speed spinning of the lower carrier rotor 130 to remove residual wash fluid.

The processing device 104 can include slide heating pads 124 which extend upwards from the floor of the basin 112 and into the bottom of the slide carrier windows 132 when the slide carrier is lowered to the bottom of the basin enclosure 110, typically during the reaction or incubation phase of the hybridization process. The heating pads 124 can align adjacent to or press against the bottom surface of the slide substrate 20, and can provide heat to the hybe solution that further excites the suspended reactants into motion and increases the efficiency of the reaction. In one aspect of the present invention, the slide heating pads can heat the slide substrates 20 up to a temperature of about 95° C. during the hybridization protocol to denature the sample and probe solution, followed by a prolonged period of heating and incubation at a lower temperature to complete the hybridization.

The processing device 104 configured as in FIG. 7 can be used to conduct a pre-hybridization wash procedure. For instance, one or more slide substrates 20 having a sample or reaction area 22 containing immobilized reactants 24 can be installed into the lower carrier rotor 130, which can then be placed onto the support axle 118 in the basin enclosure 110. The top opening of the basin enclosure can be closed with a wash cover (not shown) and the basin 112 filled with pre-hybridization wash fluid, such as a concentration of ethanol or similar cleanser, etc, to clean both the slide substrates and the reaction areas 22 and to prepare sample for hybridization. In one aspect the lower rotor may be bottomed against the base of the enclosure so that the slide carrier windows are captured by the slide heating pads 124 extending upwards from the floor of the basin 112. Alternatively, the lower rotor may be raised and rotated within the pre-hybe wash solution. In either orientation, the slide heating pads can be activated to heat the ethanol solution directly or through the slide substrate. During the pre-hybridization protocol the basin can be alternately drained and refilled with wash fluids of varying compositions, and afterwards the lower carrier rotor 130 can be removed from the bath and spun at high speed to remove any residual wash fluid from the rotor or slide substrate.

For example, a representative embodiment of a pre-hybridization wash procedure can comprise the following protocol:

Incubate slides in 2×SSC/0.5% lgepal, pH 7.0 at 37° C. for 15 minutes;

Incubate slides in 70% ethanol for 1 minute;

Incubate slides in 85% ethanol for 1 minute;

Incubate slides in 100% ethanol for 1 minute; and

Spin dry at room temperature.

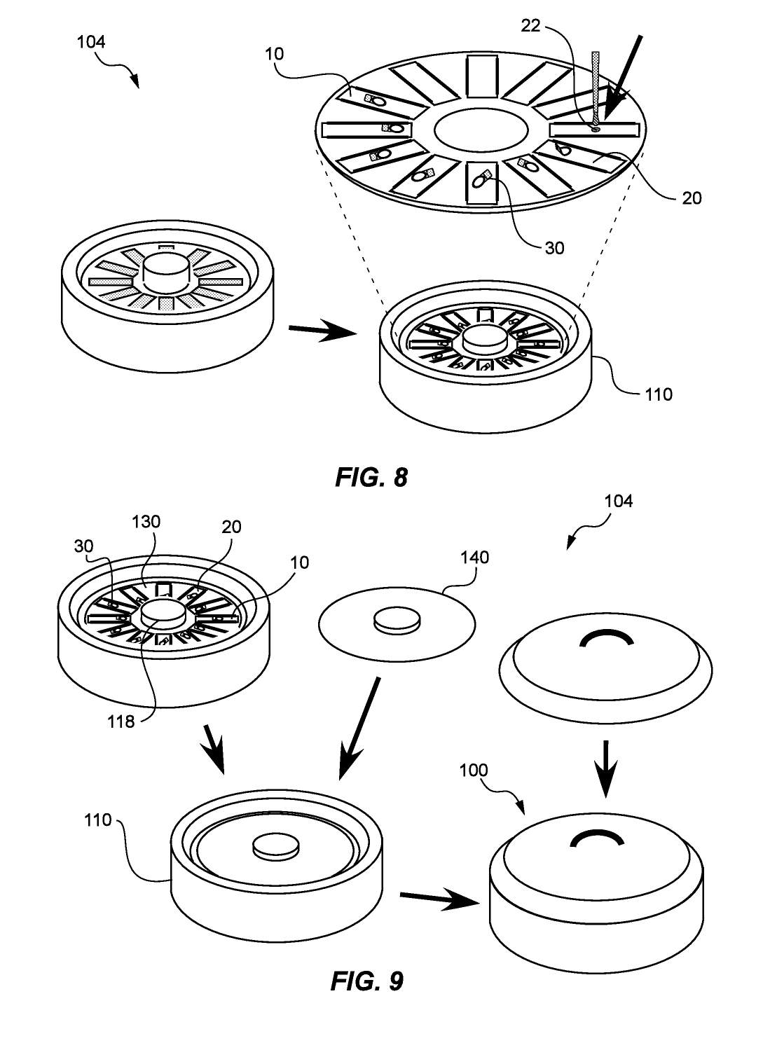

One method for filling the reaction chambers 26 with hybe or probe solution after completion of the pre-hybridization wash procedure is illustrated in FIG. 8, in which the hybe solution can be applied to the reaction areas 22 prior to attaching the reaction chamber assemblies 30 to the slide substrates 20 to form the assembled hybridization units 10. (see also FIG. 5). As described above, however, the reaction chamber assemblies 30 can also be attached to the slide substrates 20 to form hybridization units 10 prior to filling the reaction chambers through the fill ports (see FIG. 4). Regardless of the procedure used to fill the reaction chambers with hybridization fluid, the process device 104 together with hybridization units 10 can form one exemplary embodiment 100 of the present invention.

As shown in FIG. 9, once the hybridization units 10 have been formed and filled with hybe or probe solution, an upper “clamp” rotor 140 can be placed over the lower carrier rotor and the installed slide substrates to press against the top surfaces of the base layer to further seal the reaction chambers. When the disposable chamber assemblies 30, 32 and 34 described in FIGS. 1A-2B are used, the clamp rotor 140 may press on the upper pressure gaskets or directly on the base layer forming the ceiling for the reaction chamber, along with the strongly adhesive patch formed on the end tabs of the chamber assembly which can be used to remove the chamber assembly from the slide substrate after hybridization. Alternatively, when the disposable chamber assemblies 36 or 38 are used (FIGS. 3A-3B), the clamp rotor may press directly onto the strongly adhesive patch.

The upper clamp rotor 140 shown in FIG. 9 can be supported on the support axle 118 above the lower carrier rotor 130, and configured for immersion and rotation together with the lower carrier rotor within the bath of wash fluid. With the chamber assemblies 30 attached to the slide substrates 20 to form the hybridization units 10, and the hybridization units in turn installed into the lower carrier rotor, engaging the upper 140 and lower 130 rotors together can further seal the reaction chambers and bring the upper adhesive patch into contact with the clamp rotor. The adhesive patch can be strongly adhesive in order to provided attachment between the base layers of the chamber assemblies and the upper clamp rotor, even after the various heating and immersions steps encountered during the hybridization and post-hybridization protocols. Thus, the strong adhesive can ensure that subsequent disengagement of the upper and lower rotors operates to de-couple and peel the chamber assemblies 30 from off the slide substrates 20, unsealing and breaking open the reaction chambers to expose the hybridized contents to the adjacent surroundings.

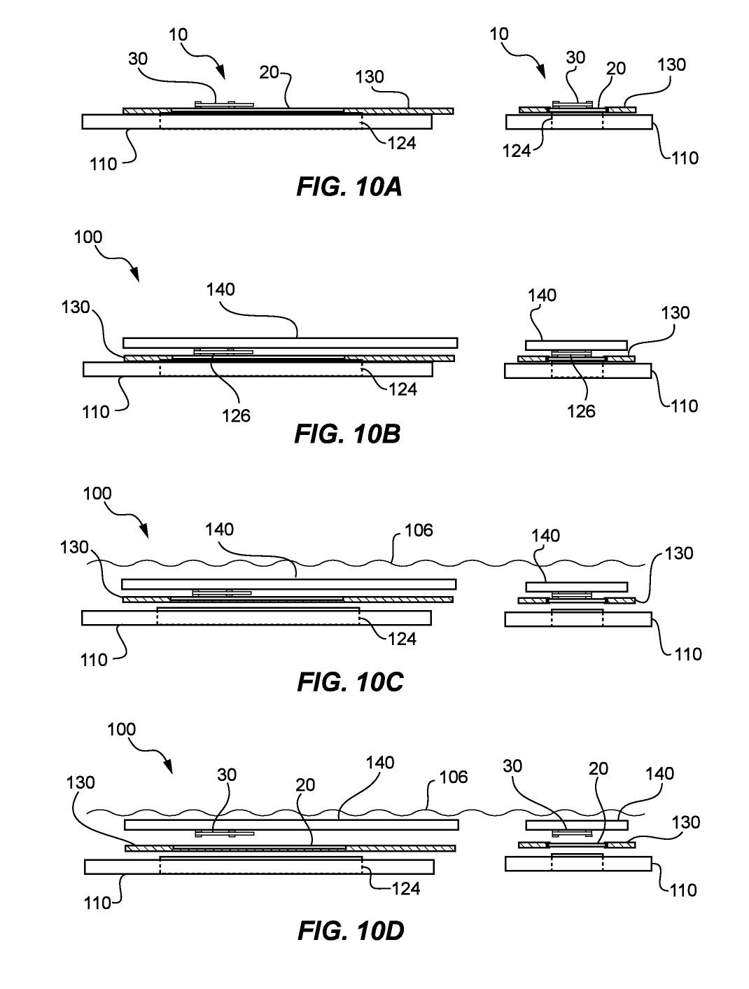

Illustrated in FIGS. 10A-10D are sectional side and end views of the upper clamp rotor and the lower carrier rotor in their various positions relative to the floor of the basin enclosure 110 and the slide heaters 124 during the various stages of the pre-hybridization, hybridization, and post-hybridization cycle. As shown in FIG. 10A, the lower carrier rotor 130 can first be located in an open, bottomed position, as can occur after attachment of the disposable chamber assembly 30 to the slide substrate 20 following a pre-hybridization wash protocol to form the hybridization unit 10. After the formation of the hybridization unit 10, both the upper clamp rotor and the lower carrier rotor can be located in a closed, bottomed position (FIG. 10B) as can occur during the hybridization protocol, a closed, raised and rotating position (FIG. 10C) as can occur at the beginning of the post-hybe wash protocol, and an open, raised and rotating position (FIG. 10D) as can occur during the subsequent stages of the post-hybe wash protocol.

For example, after a pre-hybridization protocol has been completed as described above, the lower carrier rotor 130 may be lowered to fit around the slide heating pads 124, the disposable chamber assembly 30 may be attached around the reaction area of installed slide 20, and the reaction chamber 26 may be filled with hybe (or probe) solution, as depicted in FIG. 10A. The upper clamp rotor 140 may then installed and/or lowered onto the top of the chamber assembly 30, as depicted in FIG. 10B, to engage the adhesive patches and/or pressure gaskets to complete the sealing of the hybridization chamber 126. Upon reaching this configuration the samples can be hybridized in accordance with a hybridization protocol.

For example, a representative embodiment of a hybridization protocol in accordance with FIGS. 4 and 10B can comprise:

Attach disposable chamber assembly over reaction area;

Fill reaction chamber with probe solution;

Denature sample and probe at 75° C. for 5-10 minutes; and

Incubate overnight at 37° C.

Likewise, a representative embodiment of a hybridization protocol in accordance with FIGS. 5 and 10B can comprise:

Apply probe solution onto reaction area;

Attach disposable chamber assembly over reaction area;

Denature sample and probe at 75° C. for 5-10 minutes; and

Incubate overnight at 37° C.

After the hybridization protocol is complete, the wash basin 112 can be filled with wash buffer and both rotors 130, 140 lifted together and slowly rotated while submerged with the buffer solution 106, as depicted in FIG. 10C. Subsequently, the upper clamp rotor 140 can separate from the lower carrier rotor 130, with the chamber assembly 30 adhering to the bottom surface of the upper rotor and being removed completely from the slide substrate 20, as depicted in FIG. 10D, and leaving the top surface of the slide substrate 20 exposed for washing. Breaking the gasket seal with the slide substrate submerged and slowly rotating ensures that the reaction area is protected from contamination from air-borne particles. It also ensures that a degree of fluid sheer is immediately applied to the reaction area to quickly sweep away the hybe solution and reduce the risk of cross-contamination with hybe solutions used on adjacent slides

With the rotors separated as FIG. 10D, post-hybridization wash steps, such as the exemplary post-hybe protocol can be followed to complete the cleaning and preparation of the hybridized samples for analysis. This can include the basin enclosure being alternately drained and filled with various wash buffer fluids 106, and rotating the lower carrier submerged within the buffer fluid to completely strip away the hybe solution. Removing the lower carrier rotor from the buffer fluid can be accomplished by lifting the lower carrier rotor out of the bath, or by draining the wash fluid out of the basin enclosure.

During the post-hybe stage the upper rotor 140 can be raised above the surface of the buffer fluid and separately spun at a high speed to throw off any residual wash liquid that could drip down and contaminate the slide substrates during the subsequent drying or wash buffer removal stages. In one aspect, the upper clamp rotor with its attached chamber assembly can be completely removed from the processing device for cleaning and removal of the attached chamber before the washing of the lower carrier rotor is completed.

For example, a representative embodiment of a post-hybridization wash procedure can comprise the following protocol:
Wash slides in 1×Post Wash Buffer II (2×SCC/0.1% lgepal) for 2 minutes at room temperature;
Wash slides in 1×Post Wash Buffer I (0.4×SCC/0.3% lgepal) for 2 minutes at 72° C. (+/−1° C.) without agitation;
Wash slides in 1×Post Wash Buffer II (2×SCC/0.1% lgepal) for 1 minutes at room temperature without agitation; and
Spin dry at room temperature.

The hybridization system 100 of the present invention can advantageous over the prior art by providing for a reaction stage that uses very low-volume reaction chambers, but which can be both preceded and followed by high-volume wash stages. As disclosed above, this can be accomplished by temporarily forming sealed, low-volume reaction chambers on the surface of the slide, which seals can be broken and the reaction chambers opened to expose the slide to a high volume flush or bath of wash fluid. It has been recognized that the benefits of a high-volume wash cannot be realized by forcing wash fluid through the low-volume reaction chamber utilized during the incubation cycle. It has been further recognized that removing the reaction chamber and exposing the slide to a high volume flush or bath of wash fluid can remove the used hybe solution from off the slide more completely and at a faster rate.

It is to be appreciated that the high volume flush or bath of wash fluid can be common to each of the plurality of hybridization slides. Immersing and moving a number of slide substrates through the same bath of cleansing fluid, both pre-hybe and post-hybe, provides for the simultaneous cleaning of multiple slides and for the efficient and economical use of wash fluids. Using a high volume wash, moreover, can also reduce the chance of cross-contamination, as the micro-liter-sized volumes of hybe solution samples can be thoroughly swept away and diluted within the much larger multi-liter-sized quantity of wash fluid.

Whereas the above description teaches several representative embodiments of a semi-automated hybridization slide processing system and methods for using the same, illustrated hereinbelow in FIGS. 11-22 are various embodiments of a substantially-automated hybridization slide processing system and methods for using that also include a low-volume hybridization step and a high-volume post-hybridization wash step.

Each of the exemplary embodiments of the substantially-automated hybridization system can include a hybridization unit 210, which is shown with more particularity in FIGS. 11A-11B. The hybridization unit 210 can comprise a substantially rectangular glass slide substrate 220 having a reaction area 224 that contains immobilized reactants 226, such as immobilized DNA samples. The reaction area can be covered by a disposable chamber assembly, or mixer 240, that is removably coupled to the slide substrate 220 to form a low-volume reaction chamber 244 that encloses the reaction area 224. The mixer can be attached to the slide substrate with a mixer seal 242, which can be a removable adhesive, an elastomeric seal (such as an O-ring or a gasket, including a silicone gasket) or any other sealing mechanism available in the art to form a sealed reaction chamber sufficient to hold and contain the hybridization fluid during the filling and incubation stages of the process. If a non-adhesive or elastomeric seal 242 is used, small amounts of corner adhesive 258 can be positioned on the corners of the slide to lightly couple the mixer 240 to the slide substrate 220 until the hybridization unit 210 is placed into a processing device, as discussed in more detail below. The reaction chamber 244 can be provided with a fill port 250 and a vent port 252 to allow for the introduction of hybridization fluid and the venting of enclosed air or gases.

Typically, the reaction area 224 containing the immobilized reactants 226 can substantially cover the top surface of the slide substrate 220, leaving room for the mixer seal 242 around the periphery of the microarray slide to define the outer boundaries of the reaction chamber 244. A single reaction chamber can cover the entire reaction area on the face of the slide. It is possible, however, for the immobilized reactants to be grouped into different sections and for the reaction chamber 244 to be subdivided into a plurality of individually sealed sub-chambers 246, with each sub-chamber being isolated from the adjacent sub-chambers by seal segments extending across the face of the slide. For example, the exemplary reaction chamber illustrated in FIGS. 11A-11B is subdivided into eight sub-chambers 246, with each sub-chamber having its own fill 250 and vent 252 ports. In other aspects of the present invention the number of sub-chambers can include, but is not limited to, two, four, six or twelve sub-chambers, as the need arises.

The height of the reaction chamber(s) 244, 246, as defined by the distance between the top of the slide substrate 220 and the bottom of the disposable chamber assembly or mixer 240 (or the thickness of the mixer seal) can be controlled to about 1/1000 inch (or 25 μm), although a greater height is often used. Controlling the height of the reaction chamber to about 1/1000 inch allows the volume of the chamber, and hence the volume of required hybridization fluid, to be limited to about 25 μl or less. It is to be appreciated, however, that the volume of a reaction chamber can vary from about 5 μl for a smaller sub-chamber 246 up to about 100 μl for a larger, single reaction chamber 244. This range can be considered by one having skill in the art as providing low-volume hybridization, which allows for a higher concentration of the specimens suspended in the hybridization fluid to be brought into contact with the immobilized probes on the slide 220.

The disposable chamber assembly or mixer 240 can be made from a multi-layer, flexible polymer material to form a transparent laminate structure, providing the user with the ability to see the progress of the hybridization fluid as it fills the reaction chamber(s) 244, 246 and forces the current volume of air out of the vent hole(s) 252. The mixer can also be provided with an integrated agitation system such as air bladders (not shown), that can be formed into a ceiling portion of the mixer, and which can operate to extend the ceiling portion downward into the reaction chamber(s) upon inflation. The air bladders can be pneumatically inflated and deflated to continuously mix the hybridization fluid inside the reaction chamber during incubation. Pneumatic ports 254 and lines 256 which connect the air bladders with the hybridization system can formed into one end tab 248, preferably an interior end tab, of the mixer. The mixer's pneumatic agitation system is described in more detail in U.S. Pat. No. 7,234,400, filed Aug. 2, 2002 and titled “Laminated Microarray Interface Device,” which reference is incorporated in its entirely herein.

The mixer 240 can be coupled with an optional manifold device 270 that facilitates the filling and sealing of the reaction chamber 244 or sub-chambers 246 and reduces the risk of cross-contamination of samples. The manifold can include a series of inlet holes and vent passages 272 which align with the inlet 250 and vent ports 252 in the mixer, respectively. The inlet/vent holes 272 can be formed with funnel-shaped openings 274 to capture and direct the tip of a pipette into the inlet/vent hole, and guide the hybridization fluid into the reaction chamber or sub-chambers. After filling and venting, the inlet 250 and vent 252 ports in the mixer 220 can be closed in a variety of means, including insertable plugs, a slidable seal bar integrated into the manifold, or a piercable septum layer integrated into mixer itself, etc., so that the reaction chamber(s) 244, 246 becomes a fluid-tight enclosure that is protected from outside contamination during the incubation stage of the hybridization process. Furthermore, the manifold 270, the mixer 240 and the mixer seal 242 can be configured as a mixer/manifold sub-assembly 280. Both the mixer 240 and the mixer/manifold sub-assembly can be disposable and configured for easy coupling and de-coupling with the top surface of the slide substrate 220.

The hybridization unit 210 can also be configured so that the borders of the mixer 240 extend beyond one pair of parallel edges 230 of the slide substrate and expose the other pair of parallel edges 232. In the exemplary embodiment shown in FIGS. 11A-11B, the mixer extends further along the long axis (beyond the short edges) of the slide substrate to provide a pair of end tabs 248 at both ends 230 of the hybridization unit. At the same time, the disposable chamber assembly or mixer 240 can be narrower than the width of the slide substrate 220, and exposes the pair of edges 232 bordering the length of the slide substrate. In another aspect of the present invention the sets of parallel edges can be switched, with the flaps of the mixer covering and extending beyond the long edges of slide substrate, and the short edges at either end of the slide substrate remaining exposed.

As will be discussed in more detail below, this configuration allows for the mixer 240 to be coupled to an upper clamp fixture of a processing device, and for the slide substrate 220 to be coupled to a lower carrier fixture of the processing device. After receiving the mixer and the slide substrate, the upper and lower fixtures can be engaged together, coupling the mixer and the slide substrate to form the reaction chamber(s) 244, 246. Disengagement of the upper and lower fixtures operates to de-couple the mixer from the slide substrate, unsealing and breaking open the reaction chamber(s) 244, 246.

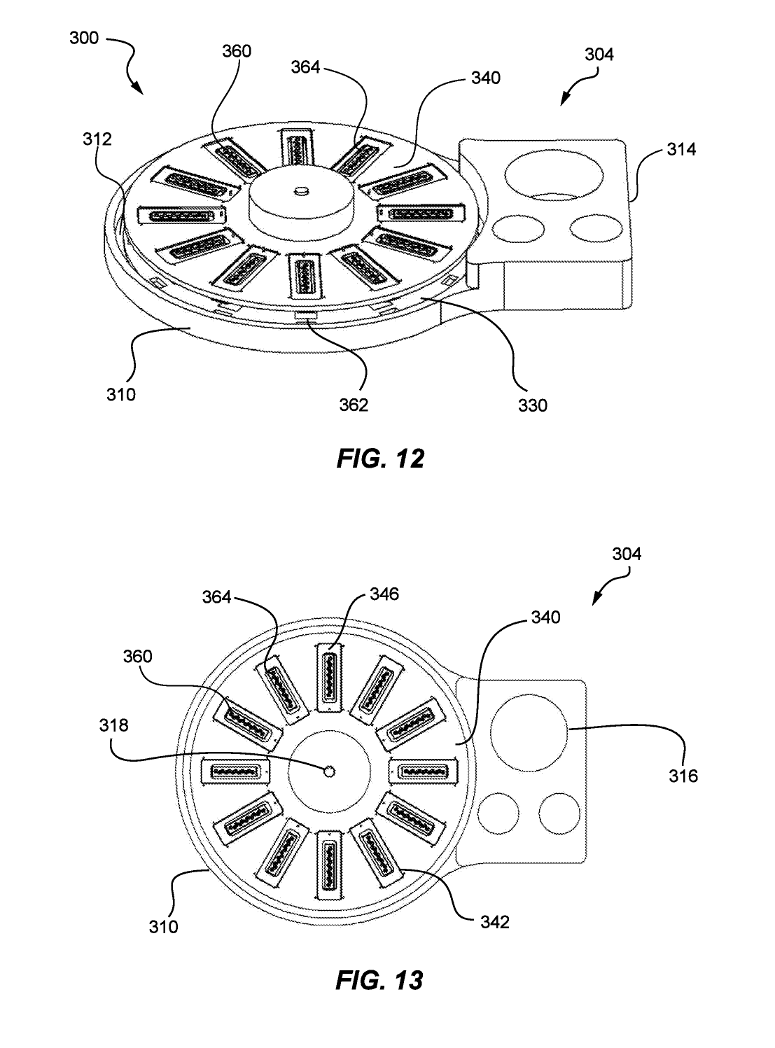

A processing device 304, which together with the hybridization unit 360 forms an exemplary embodiment 300 of the present invention for the substantially-automated hybridization of a plurality of microarray slides, is generally illustrated in FIGS. 12-15. The processing device 304 can include a basin enclosure 310 having an open top end. The basin enclosure can include a basin 312 that is configured to hold a quantity of wash fluid for washing the microarray slides after completion of the hybridization process. The basin 312 can be circular, as illustrated, or can have any other shape or configuration capable of temporarily holding or containing a quantity of wash fluid sufficient to immerse or submerge the plurality of microarray slides, which range can include, but is not limited to, 0.1 to 3.0 liters of wash fluid. The basin enclosure 310 can further include a side section 314 having recesses 316 for holding wash fluid bottles, as well as internal plumbing such as valves and pipes for filling and draining the wash fluid from the basin.

The processing device 304 can include a slide carrier disposed within the basin enclosure 310, and configured to receive a plurality of microarray slide substrates 362. The slide carrier can be a lower carrier rotor 330 supported on a support axle 318 and driven by a spin motor 320, as shown in the illustrated embodiment, that allows rotational movement of the lower carrier rotor (including the received slide substrates) relative to the basin 312 and the wash fluid held therein. Furthermore, the lower carrier rotor 330 and the basin enclosure 310 can be configured together for immersing the lower carrier rotor within a bath of wash fluid contained within the basin 312, followed by removing the lower carrier rotor from the bath and stripping off any residual wash fluid. Removing the lower carrier rotor from the bath can be accomplished by lifting the lower carrier rotor out of the bath, or by draining the wash fluid out of the basin enclosure. In one aspect of the invention, the lower carrier rotor 330 can be both raised away from the floor of the basin 312 and rotated about the support axle 318 while the wash fluid is drained.

The processing device 304 can further include a clamp plate disposed above the slide carrier, and configured to receive a plurality of mixer/manifolds 364 or individual mixers 366. The clamp plate can be an upper clamp rotor 340 supported on the same support axle 318 and above the lower carrier rotor 330, as shown in the FIGS. 12-15. The support axle 318 can be segmented to allow for differential rotational movement of the upper clamp rotor 340 relative to both the basin enclosure 310 and to the lower carrier rotor 330. The upper clamp rotor can also be configured for immersion and rotation within the bath of wash fluid contained within the basin 312.

In the rotating embodiment of FIGS. 12-15, the upper clamp rotor 340 and lower carrier rotor 330 can be configured for engagement one with the other by providing for relative vertical movement between the two discs. When engaged, the plurality of mixer/manifolds 364 previously received by the upper clamp rotor 340 can couple to the plurality of slide substrates 362 previously received on the lower carrier rotor 330, to form a plurality of a hybridization units 360 with sealed hybridization reaction chambers. And when disengaged, the separating motion between the upper clamp rotor and the lower carrier rotor causes the mixer/manifolds 364 to de-couple from the slide substrates 362, pulling the mixers off the slide substrates and breaking open each of the mixer seals that form the plurality of reaction chambers.

The mixer/manifolds 364 coupled to the upper clamp rotor 340 can be angularly aligned with the slide substrates 362 coupled to the lower carrier rotor 330 before the two rotors are brought together. This can be accomplished by monitoring and controlling the angular position of both rotors until the mixer/manifolds and slide substrates align.

The slide substrates 362 can be inserted into equally-spaced carrier rotor ‘windows’ 332 formed into the lower carrier rotor 330. The carrier rotor windows 332 can have slots or grooves formed in the interior side surfaces for receiving and grasping the exposed edges of the slide substrates not covered the mixer, and flexible tabs at the ends of the slots that flex open during installation and snap closed afterwards to prevent the slide substrate 362 from being flung out of window 332 during rotation, especially during high-speed spinning of the lower carrier rotor 330.

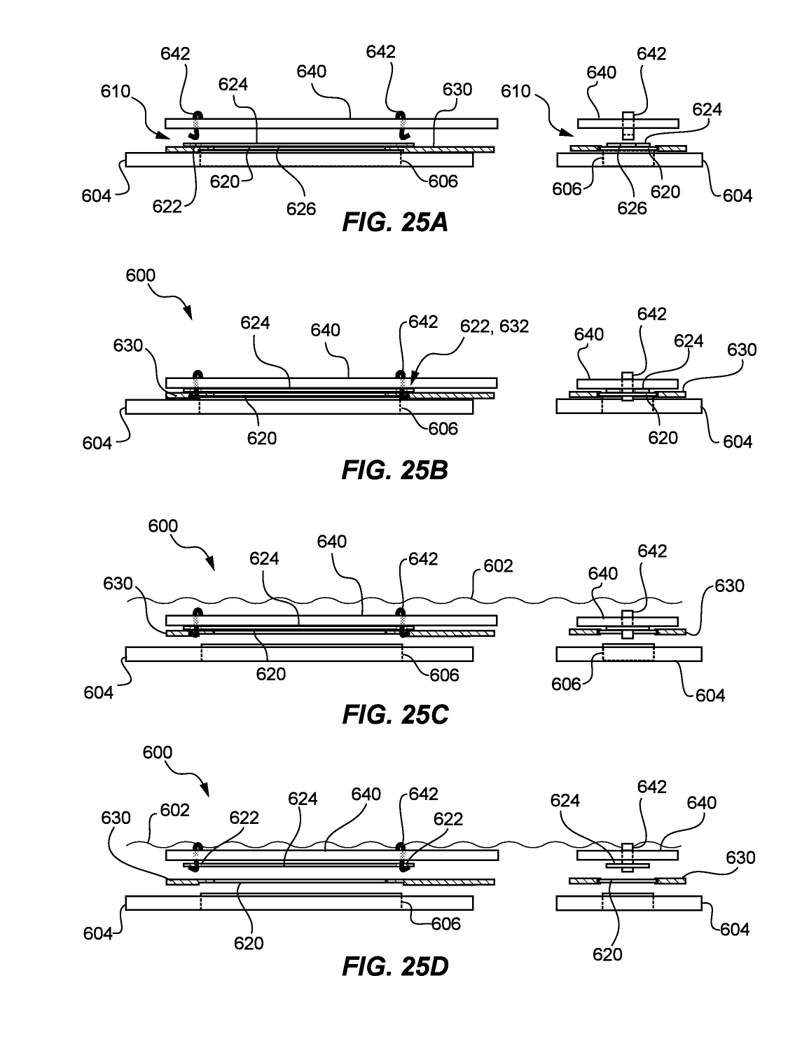

The mixer/manifolds 364 can attach to the upper clamp rotor 340 via the end tabs of the mixer 366 extending lengthwise beyond the edges of the slide substrate (see FIG. 15). The end tabs can be grasped by clips or tabs formed at both ends of a clamp rotor ‘window’ 342 that extend downwards towards the lower carrier rotor. The clips may function not only as connection points with the end tabs, but to also serve as interlocking alignment and engagement features that better align and secure the two rotors together. An additional embodiment using clips 642 is illustrated in FIGS. 24 and 25A-25D.

Referring back to FIG. 15, the upper clamp rotor 340 can be configured to receive both individual mixers 366 or mixer/manifold sub-assemblies 368, in which the manifold can be coupled to the mixer prior to loading into the clamp rotor to facilitate the subsequent filling, venting and sealing of the reaction chambers or sub-chambers.

In one aspect of the present invention the clamp rotor window can be equipped with a flexible “floating lid” 346 secured about the inner edge of the clamp rotor window 344 that spans the gap between the inner edge of the window and the manifold 368. When the two rotors are separated, the floating lid can operate to snuggly fit around and grasp the manifold, to further secure the mixer/manifold 364 to the clamping plate rotor. And when the upper clamp rotor 340 is engaged with lower carrier rotor 330, with or without the manifold, the floating lid 346 can function as a planar spring that presses down on the top surface of the mixer 366 to fully compress the mixer seal and create the fluid-tight reaction chamber. Using the spring-like floating lid to press against the top surface of the mixer provides for greater tolerances when engaging the upper and lower rotors, and avoids the application of excessive force by the clamping plate rotor that might cause a slide substrate 362 to crack or break.

In another aspect of the present invention the manifolds 368 may be permanently attached to the upper clamp rotor 340, with only the mixers 366 being removable and disposable with each cycle of the hybridization process. Furthermore, the manifolds can be configured with a universal pattern of filler funnels and vent passages to accommodate the various sub-chamber configurations available with the mixer shells.

In yet another aspect of the present invention, the mixer/manifolds 364 or mixers 366 can be coupled to the slide substrates 362 prior to mounting of the slides into the lower carrier rotor 330. After receiving the pre-assembled hybridization units 360, the clamp rotor 340 can be lowered to engage the carrier rotor and to apply the necessary pressure to the top of the mixer 366 to properly seal the reaction chambers. The clamp rotor can also automatically attach to the end tabs of the mixer, so that subsequent lifting of the clamp rotor breaks the mixer seal and removes the mixer 366 or mixer/manifold 364 from off the slide substrate 362, as described above.

Air lines for connection with the pneumatic lines in the mixer can be formed in or attached to the upper clamp rotor. The air lines can terminate in exit holes with elastomeric seals that align with the pneumatic ports in the mixer. Pressing the upper clamp rotor against the top surface of the mixer, to create the fluid-tight reaction chamber between the mixer and the slide substrate, simultaneously creates an air-tight seal between the air line terminations and the pneumatic ports in the end tab of the mixer.

Additional aspects of the hybridization system can include slide heaters 324 which extend upwards from the floor of the basin 312 and into the bottom of the slide carrier windows 332 when the slide carrier is lowered to the bottom of the basin enclosure 310, typically during the reaction or incubation phase of the hybridization process. The slide heaters 324 can align adjacent to or press against the bottom surface of the slide substrate 362, and can provide heat to the hybridization fluid that further excites the suspended reactants into motion and increases the efficiency of the reaction. In one aspect of the present invention, the slide heaters can heat the slide substrate 362 up to a temperature of about 95° C.

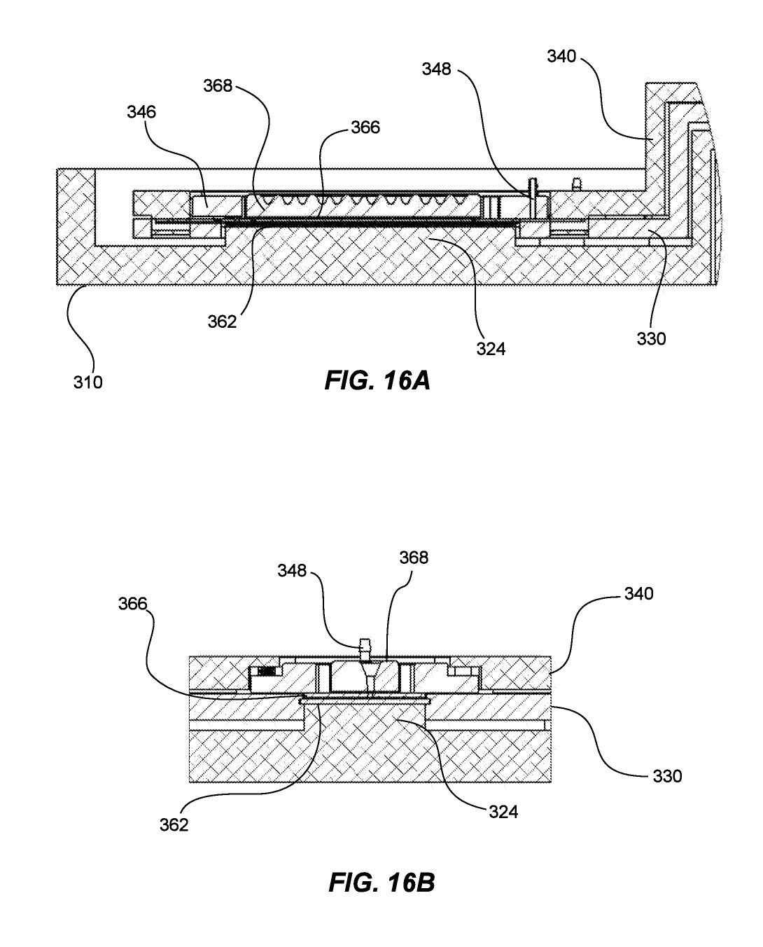

Illustrated in FIGS. 16A and 16B are sectional side and end views of the upper clamp rotor 340 and the lower carrier rotor 330 in a closed position, as can occur during the filling and incubation stages of the hybridization process. In this position, the joined rotors can be positioned at the bottom of the basin enclosure 310, with the heaters 324 projecting upwards into the carrier rotor window and contacting the bottom of the slide substrate 362. The upper clamp rotor can bear down on the outer edges of the top surface of the mixer 366 with the floating lid 346, forcing the mixer seal firmly against the top surface of the slide substrate 362 to form the reaction chambers with fluid-tight seals. A manifold 368 can be coupled to an interior portion of the top surface of the mixer and aligned with the inlet and vent ports. Furthermore, the air lines 348 in the upper clamp rotor can be placed in pneumatic communication with the pneumatic ports in the mixer, allowing operation of the mixer air bladders to agitate and mix the hybridization fluid during incubation.

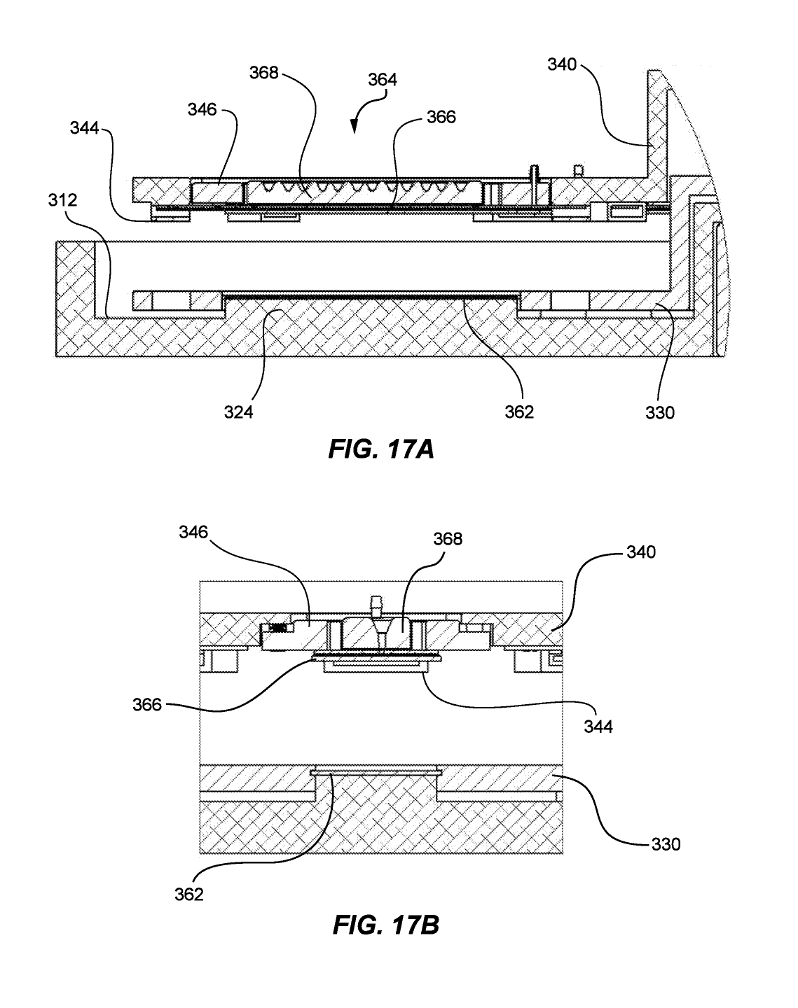

Illustrated in FIGS. 17A and 17B are sectional side and end views of the upper clamp rotor 340 and the lower carrier rotor 330, and after the upper clamp rotor has been lifted away from the lower carrier rotor to separate the mixer/manifold 366 and the slide substrate 362, upon completion of the incubation stage. The lifting movement of the upper clamp rotor can break open mixer seal forming the reaction chambers and pull the mixer off the slide substrate, leaving the top surface of the slide substrate exposed for washing. The basin 312 can be filled with wash fluid to completely immerse the two rotors before the upper rotor is lifted away and the mixer de-coupled from the slide substrate. Breaking the mixer seal with the slide substrate submerged can allow for the reaction area on top of the slide substrate to be immediately flushed with wash fluid upon the opening of the reaction chamber, to minimize the possibility of cross-contamination of the contents of any reaction chamber onto a neighboring array.

During the washing process the basin enclosure can be alternately drained and filled with various wash fluids to completely strip away the hybridization fluid. At this stage in the hybridization process the upper rotor 340 can be lifted out and above the basin enclosure and separately spun at a high speed to throw off any residual wash liquid that could drip down and contaminate the slide substrates during the subsequent drying or wash water removal stage. In one aspect of the present invention the upper clamp rotor, with its attached mixers and manifolds, can be completely removed from the processing device for cleaning and removal of the mixer/manifolds 364 before the washing of the lower carrier rotor is completed.

Further illustrated in FIGS. 17A and 17B are the clamp rotor clips or tabs 344 which can extend downwards from the clamp rotor and attach to the end tabs of the mixer 366, and which can operate to pull the mixer off the slide substrate 362 and break apart the hybridization unit 360 when the upper clamp rotor 340 is lifted away lower carrier rotor 330. Also shown is the floating lid 346 that can press down on the top surface of the mixer 366 to fully compress the mixer seal and create a hybridization unit with a fluid-tight reaction chamber when the two rotors are coupled together, and which can also grasp the manifold 368 and further secure the mixer/manifold 364 to the clamping plate rotor 340 during the separation of the two disc rotors.

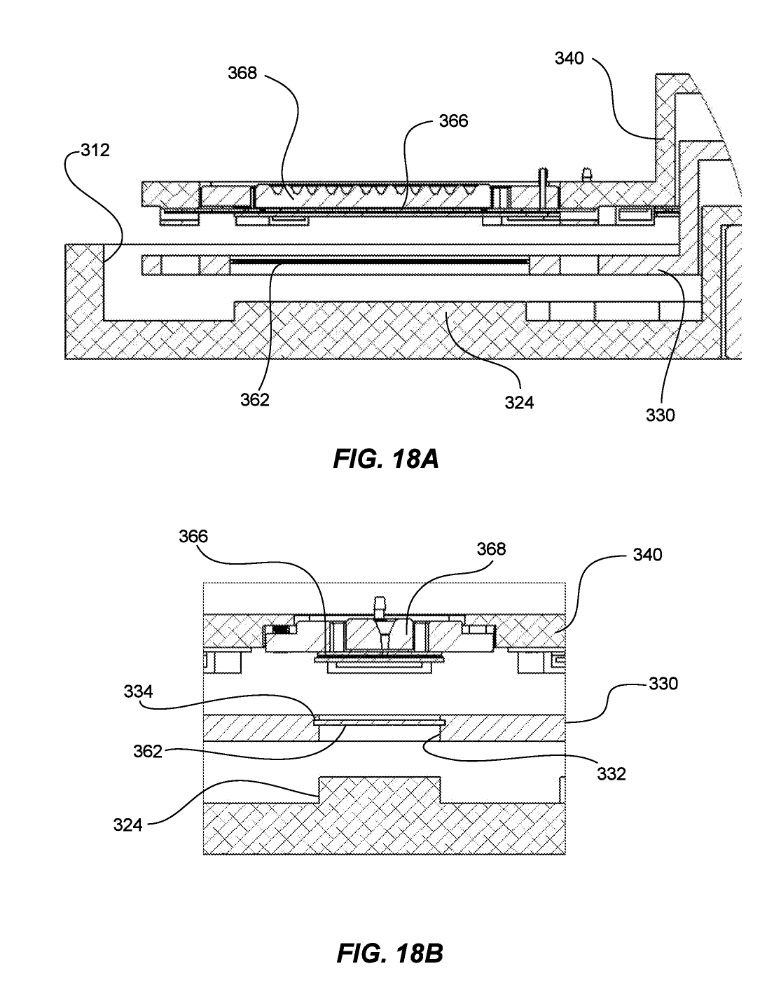

As illustrated in FIGS. 18A and 18B, the lower carrier rotor 330 can also be lifted off the projecting slide heaters 324 and partially away from the bottom of the basin 312, so as to allow the disc to rotate around its supporting axle during the washing stage and create a relative motion or current flowing over and around the slide substrate 362. This can provide for a faster and more thorough cleaning of both the reaction area and bottom surfaces of the slide substrate. Moreover, the rate of rotation can be moderated to avoid damaging the hybridized immobilized reactant probes.

In another aspect of the invention, the joined rotors 330, 340 can both be lifted off the projecting slide heaters 323 and rotated together while the basin 312 is filled with sufficient wash fluid to submerge the rotating rotors, prior to separating the discs. This ensures that a degree of fluid sheer is present at the de-coupling of the mixers 366 or mixer/manifolds 364 from the slide substrates 362, to quickly sweep away the hybridization fluid on the slide and reduce the risk of cross-contamination. This can be especially advantageous for microarray slides having multiple sub-chambers, which when opened may allow for undesirable intermixing of the various hybridization samples unless all of the fluids are quickly removed. Inducing a flow of wash liquid over the surface of the slide through rotation of the rotor discs can minimize the risk of cross-contamination.

Like the semi-automated hybridization slide processing system described above, the substantially-automated hybridization system 300 is advantageous over the prior art by providing for a reaction stage that uses very low-volume reaction chambers followed by a high-volume wash stage. As disclosed above, this can be accomplished by temporarily forming sealed, low-volume reaction chambers on the surface of the slide, which seals can be broken and the reaction chambers opened to expose the slide to a high volume flush or bath of wash fluid. It has been recognized that the benefits of a high-volume wash cannot be realized by forcing wash fluid through the low-volume reaction chamber utilized during the incubation cycle. It has been further recognized that removing the reaction chamber and exposing the slide to a high volume flush or bath of wash fluid can remove the used hybridization fluid from off the slide more completely and at a faster rate.

It is further recognized that the high volume flush or bath of wash fluid can be common to each of the plurality of microarray slides. Immersing and moving a number of slide substrates through the same bath of cleaning fluid provides for the simultaneous cleaning of multiple slides and for the efficient and economical use of wash fluids. Using a high volume wash, moreover, can also reduce the chance of cross-contamination, as the micro-liter size of the hybridization fluid samples can be thoroughly swept away and diluted within the much larger liter-sized quantity of wash fluid.

Further illustrated in FIGS. 18A and 18B are the slide coupling grooves or slots 334, which can be formed in the carrier rotor window 332 for receiving and grasping the exposed edges of the slide substrates that are not covered by the mixer.

Referring back to the rotating embodiment illustrated in FIGS. 12-15, the wash stage can include the use of multiple wash fluids, during which process the basin 312 in the basin enclosure 310 can be alternately drained and filled, and during which the lower carrier rotor 330 and attached slide substrates 362 are continuously rotated. After the wash stage is complete, the basin enclosure can be drained of all fluids and the lower carrier rotor spun at a higher rotational speed to throw off any residual wash fluids through centripetal action. In another aspect of the invention, the upper clamp rotor 140, positioned directly above the lower carrier rotor, can be provided with downwardly directed nozzles that provide jets of nitrogen gas, or humidified or ozone-free air to blow any residual wash fluids off the surfaces of the slide before they can dry and spot the hybridized reaction area.

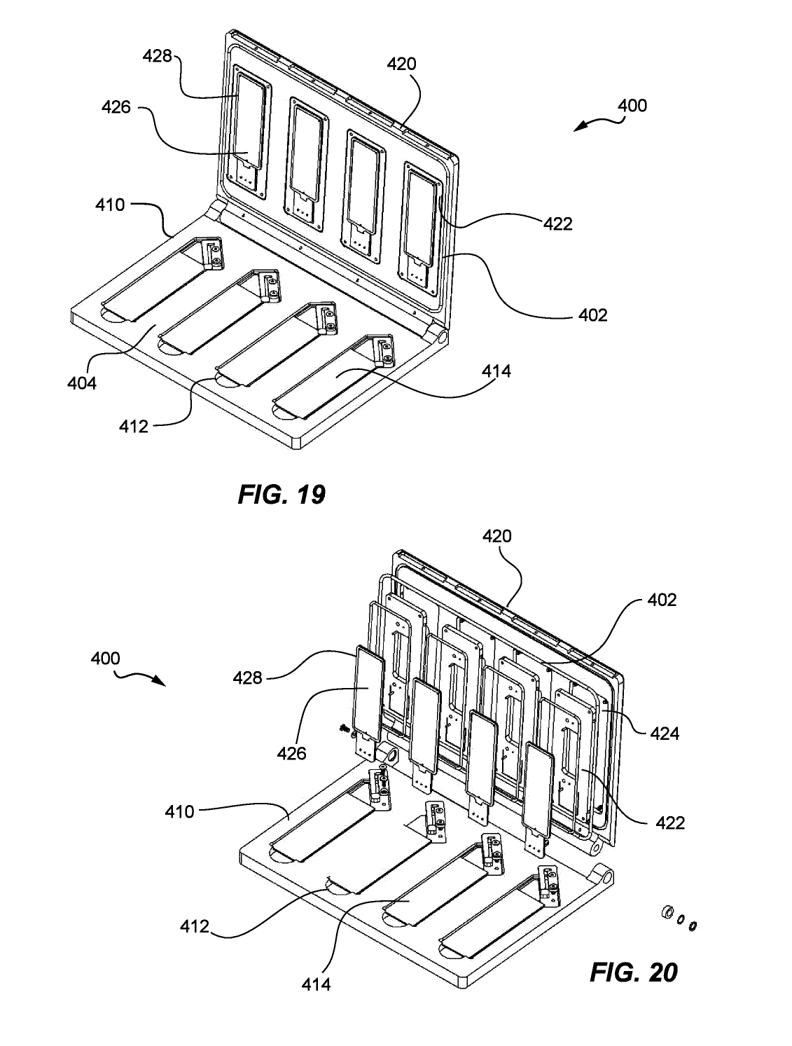

Another exemplary embodiment 400 of the present invention that uses non-rotating components is illustrated generally in FIGS. 19 and 20. The embodiment can include a basin enclosure 410 having an open top end. The basin enclosure can be configured to hold a quantity of wash fluid sufficient to immerse or submerge a plurality of microarray slides after completion of the incubation state of the hybridization process. The basin enclosure can be rectangular, and can further include a side section (not shown) having recesses for holding wash fluid bottles, as well as internal plumbing such as valves and pipes for filling and draining the wash fluid from the basin enclosure. The internal plumbing can be configured for rapid draining and filling to reduce the time during which the slides are not submerged.

The processing device can include a lower carrier plate or fixture 412 disposed within the basin enclosure and configured to receive a plurality of microarray slide substrates 414. In the embodiment shown, the lower fixture 412 can be formed into the bottom surface of the basin enclosure 410. The processing device can also include an upper clamp plate or fixture 422 disposed above the lower plate, and configured to receive a plurality of disposable mixers 426. The upper clamp fixture can be common to all the mixers, or the processing device can be configured with individual clamp fixtures for each mixer, as shown.

In the non-rotating embodiment of FIGS. 19 and 20, the clamp fixture(s) 422 can be associated with the top cover 420 of the processing device, and can be configured with a piston-like actuator 424 to provide for relative motion and engagement between the upper fixture(s) 422 and the lower fixture 412. When engaged, the plurality of mixers 426 with mixer seals 428 previously received by the clamp plate can couple to the plurality of slide substrates 414 previously received on the carrier plate 412, to form a plurality of sealed hybridization reaction chambers. And when disengaged, the separating motion between the upper clamp fixture and the lower carrier fixture causes the plurality of mixers to de-couple from the plurality of slide substrates, pulling the mixer seals off the slide substrates and breaking open each of the plurality of reaction chambers.

The top cover 420 can coupled to the basin enclosure 410 and seal with an outer wash chamber seal 402 to form an outer chamber 404 that completely surrounds and encloses the plurality of hybridization units. Once the cover is secured over the basin, the piston-like actuators 424 can activate to close the gap between the mixers 426 and the slide substrates 412 to form the individually-sealed hybridization reaction chambers, and withdraw to remove the mixers from the slide substrates after incubation is complete.

Flushing and washing the hybridized slide substrates after completion of the incubation stage can be accomplished by flowing wash fluids through the enclosed outer wash chamber 404 that is common to all of the microarray slides installed into the processing device. The wash fluid can be caused to move or flow relative to the received slide substrates 412 with a liquid pump or similar device. Removal of the wash fluids after the wash cycle is complete can be accomplished by draining the wash fluids out of the wash chamber and providing downwardly directed jets of nitrogen gas or humidified or ozone-free air onto the tops of the slide substrate to remove any residual wash fluids.

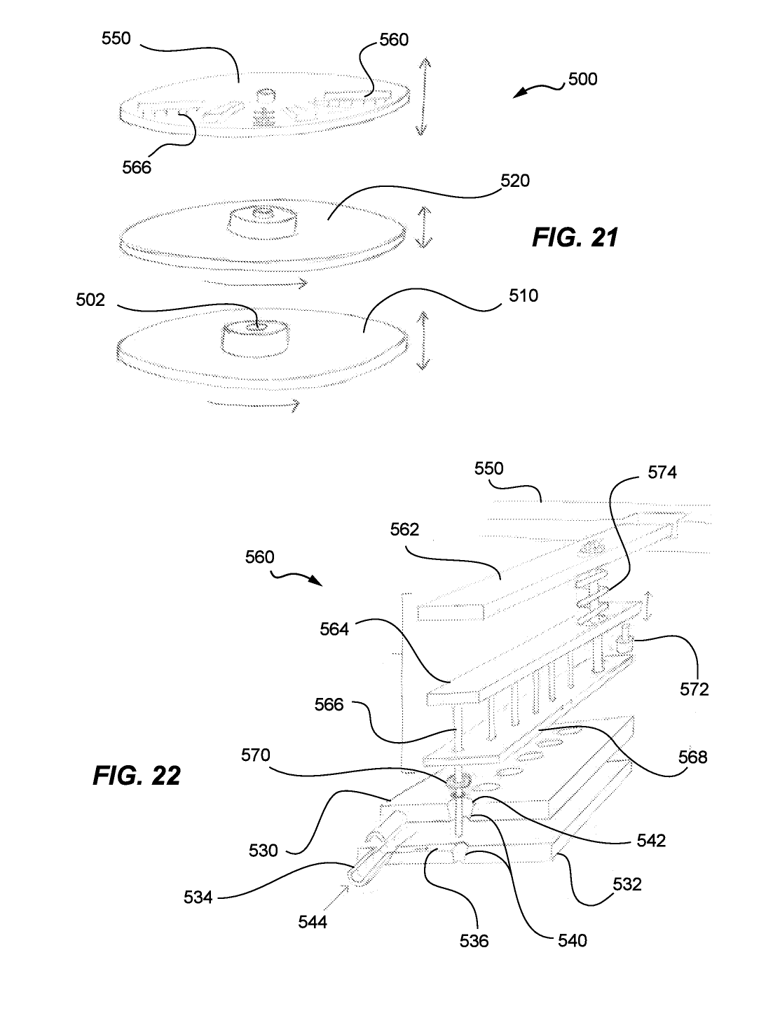

Illustrated in FIG. 21 is yet another embodiment 500 of the hybridization system of the present invention, which embodiment employs three disc plates or rotors. The lower rotating discs can comprise a lower carrier rotor 510 and an upper clamp rotor 520, which both move up and down and rotate about the support axle 502. The embodiment shown in FIG. 21 can also include a third top valve disc 550. The valve disc can be configured for movement in the axial direction (up and down), and may or may not rotate with the lower disc rotors.

The top valve disc 550 can be configured with a plurality of valve stations 560 configured for interconnection with the plurality of manifolds/mixers mounted on the clamp rotor below. Extending outwardly, or downwardly from the bottom, of each valve station 560 can be a set of valve pins 566 that can be inserted into a series of inlet/vent holes 540 formed in the manifold (similar to the holes 272 and funnels 274 in the manifold illustrated in FIG. 11B). The valve pins can be solid, and can be formed from a hardened or stainless metallic material. The valve pins can be used to control the flow of fluid both into and out of the reaction chamber(s), and to act as plugs to seal the reaction chamber(s) during the incubation stage. Although described in conjunction with an embodiment 300 of the hybridization system using a rotating processing device, the valve station can also be configured to work with the non-rotating processing device.

One embodiment of the valve station 560 is shown in more detail in FIG. 22. The valve station can include a plurality of plates, including a top plate 562 providing a fixed base of movement, a valve pin activation plate 564, and an O-ring retaining plate 568 for guiding and maintaining the valve pins 566 in the proper position and orientation. The actuation plate 564 can be biased in the downward direction with a spring 574, but its vertical position can be controlled by an air-powered (pneumatic) piston 572 or similar actuation device. An O-ring 570 concentric with each valve pin 566 creates a seal between the valve pin and the funnel-shaped openings 542 in the manifold when the valve station 560 is coupled to the mixer/manifold below.

The valve pins 566 can interconnect with the inlet/vent holes 540 in the manifold and seal the holes during hybridization. The inlet/vent holes in the manifold can be provided with funnel-shaped openings 542 for receiving and guiding the valve pins 566 into the inlet/vent holes. In one aspect of the invention the manifold can be separated into an upper manifold 530 and lower manifold 532, and internal fluid passages can be formed therein. For example, the manifold can have a main fluid line 534 connecting to a plurality of transfer fluid lines 536, which can intersect with the inlet/vent holes 540 at the split line between the upper manifold 530 and lower manifold 532. In one aspect of the invention, the valves pins 566 can be partially withdrawn to allow fluid 544 from the main line 534 to flow down through the inlet ports 540 and into the reaction chambers. Likewise, the valve pins can be partially removed to allow reversible flow of displaced fluid out of the vent passages, through the fluid passages and into an appropriate collection device (not shown).

The method of the present invention utilizing the valve disc 550 can include mounting the slide substrates into the lower carrier rotor 510 and the mixer/manifolds into the upper clamp rotor 520, and lowering the clamp rotor to engage the carrier rotor and couple the mixer/manifolds to the slide substrates to form reaction chambers. The reaction chambers can then be filled with hybridization fluid through the funnel-shaped openings 542 in the manifold. After filling, the valve disc 550 with downwardly projecting valve pins 566 can be lowered into the inlet/vent ports 540 of the manifold to seal the reaction chambers. Hybridization can then take place, with mixing during the incubation stage controlled with pressurized air delivered to the bladders formed in the mixers.

After hybridization is complete, the valve disc 550 can be raised and the basin filled with wash buffer sufficient to immerse the lower rotors 510, 520. The lower rotors can be rotated within the wash buffer to create an immediate flow of fluid over the slide substrates as the clamp rotor is separated from the carrier rotor, breaking open the sealed chambers covering the reaction areas. The wash cycle for the slide substrates received into the lower carrier rotor can continue as described previously.

In another aspect of the embodiment 500 of FIGS. 21-22, the method can further include bringing the clamp rotor 520 and carrier rotor 510 back together after the wash cycle is complete to re-establish the reaction chambers. The valve disc 550 can be lowered and the valve pins 566 re-inserted into the mixer/manifolds, and a variety of fluidic steps, such as nucleic acid denaturation and recovery, can be performed on the hybridized and washed microarray slides.

It can be appreciated that the valve station 560 can provide additional flexibility in processing and washing the slide substrate after hybridization. After incubation is complete, for instance, the valve pins 566 plugging the inlet/vent holes 540 can be partially opened by the pneumatic pistons 572 and elution buffer slowly pumped into the reaction chambers to wash the reaction areas and displace the hybridization fluid, which can be pushed out through the vent passages and collected with an appropriate collection device positioned below the vent outlets. The valve pins can then be re-lowered to seal the reaction chambers, and the slide substrate and mixer (e.g. the hybridization unit) reheated. Upon completion of the second processing step, the valve pins can be re-opened and additional heated elution buffer pumped through the reaction chambers to force the reacted fluid into another collection device.

Furthermore, in the case of the non-rotating processing device, after hybridization is complete the valve pins 566 plugging the inlet holes 540 can be partially opened and wash fluid pumped into the reaction chamber with enough pressure to push up the clamp fixture, break the mixer seal, and separate the mixer from slide substrate. The outer wash chamber seal can remain intact to maintain the high volume wash chamber. After the washing sequence is complete, the wash fluid can be replaced by nitrogen gas, or humidified or ozone-free air to remove any residual wash fluid from the slide.

In both the rotating and non-rotating embodiments of the processing device, the use of valve pins 566 (see FIGS. 21-22) can provide significant benefits over the prior art. For instance, the valve pins and valve stations 560 can be simple to fabricate with minimal moving parts, reducing the manufacturing costs of the processing device. Using valve pins to seal the filled reaction chambers for incubation is also less expensive than present conventional sealing methods, such as manually-applied tape. Solid, metallic valve pins can provide more reliable sealing with repeated use, as the softer contact surfaces of the disposable manifold's funnel-shaped openings 542 to the inlet holes 540 become the wear point, and are continuously replaced. Most significantly, however, the valve pin and manifold system can reduce the “dead” volume between the inlet and vent ports of the reaction chamber and the tip of the pin valves to a very small amount, in the range of 1-3 μl, thereby conserving the quantity of hybridization fluid needed to perform the test.

FIGS. 23 and 24 illustrate another representative embodiment 600 of the present invention. Similar to the semi-automated hybridization slide processing system and methods described hereinabove, a disposable chamber assembly 624 can be removably coupled to a slide substrate 620 to create a sealed reaction chamber 626 surrounding a reaction area to form a hybridization unit 610. In this case the hybridization unit 610 may not require a manifold for the automated dispensing of hybe solution into the reaction chambers, but can include fill and vent holes for manually filling of the reaction chambers with a pipette prior to installation into a carrier rotor 630. Similar to the substantially-automated hybridization system also described hereinabove, however, the hybridization unit 610 can also include one or more reaction chambers 626 formed into the disposable chamber assembly 624, and can further include a pair of end tabs 628 extending beyond the short edges of the slide substrate 620. Each end tab 628 can include an attachment hole 622 for flexibly receiving a clip 642 extending downward from the upper clamp rotor 640.

The lower carrier rotor 630 can also include recesses 632 at both ends of the carrier window configured to receive the clips 642. For instance, after the lower carrier rotor 630 with installed hybridization units 610 has been placed into the basin enclosure 604, with the slide substrates adjacent 620 to the slide heaters 606 (FIG. 23), the upper clamp rotor 640 can loaded into the basin enclosure and the downwardly-extending clips 642 from the upper clamp rotor 640 can push through the attachment holes 622 in the disposable chamber assembly 624 and enter the recesses 632 formed into the lower carrier rotor (FIG. 24). In one aspect the clips 642 can interlock with the recesses 632 to better align and secure the two rotors together. The basin enclosure 604 with installed rotors 630, 640 can then be enclosed with a cover 608.

The operation of the downwardly-extending clips 642 during the hybridization protocol is further shown in FIGS. 25A-25D, which illustrate sectional side and end views of the upper clamp rotor and the lower carrier rotor in their various positions relative to the floor of the basin enclosure 604 and the slide heaters 606 during the various stages of the pre-hybridization, hybridization, and post-hybridization cycle. As shown in FIG. 25A, the lower carrier rotor 630 can first be located in an open, bottomed position adjacent the slide heaters 606 after attachment of the hybridization unit 610. The upper clamp rotor and the lower carrier rotor can both be subsequently located in a closed, bottomed position (FIG. 25B) as can occur during the hybridization protocol, a closed, raised and rotating position (FIG. 25C) as can occur at the beginning of the post-hybe wash protocol, and an open, raised and rotating position (FIG. 25D) as can occur during the subsequent stages of the post-hybe wash protocol.

For example, the disposable chamber assembly 624 may be attached around the reaction area(s) of slide substrate 620, and the reaction chamber (s) 626 may be filled with hybe (or probe) solution prior to installing the hybridization unit 610 into the lower carrier rotor 630. After installation of the hybridization units, the lower carrier rotor can then be located to fit around the slide heating pads 606, as depicted in FIG. 25A. The upper clamp rotor 640 may then installed and/or lowered onto the top of the chamber assembly 624, as depicted in FIG. 25B, to engage the clips 642 within the holes 622 formed in the tabs of the disposable chamber assembly and within the recess 632 formed in the slide carrier rotor, and to complete the sealing of the hybridization chamber(s) 126. Upon reaching this configuration the samples can be hybridized in accordance with a hybridization protocol.

After the hybridization protocol is complete, the wash basin can be filled with wash buffer 602 and both rotors 630, 640 lifted together and slowly rotated while submerged with the buffer solution, as depicted in FIG. 25C. The upper clamp rotor 640 can then separate from the lower carrier rotor 630, with the chamber assembly 624 held to the bottom surface of the upper rotor by clips 642 and being removed completely from the slide substrate 620, as depicted in FIG. 25D, leaving the top surface of the slide substrate 620 exposed for washing. As described above, breaking the reaction chamber seal with the slide substrate submerged and slowly rotating ensures that the reaction area is protected from contamination from air-borne particles. It also ensures that a degree of fluid sheer is immediately applied to the reaction area to quickly sweep away the hybe solution and reduce the risk of cross-contamination with hybe solutions used on adjacent slides.

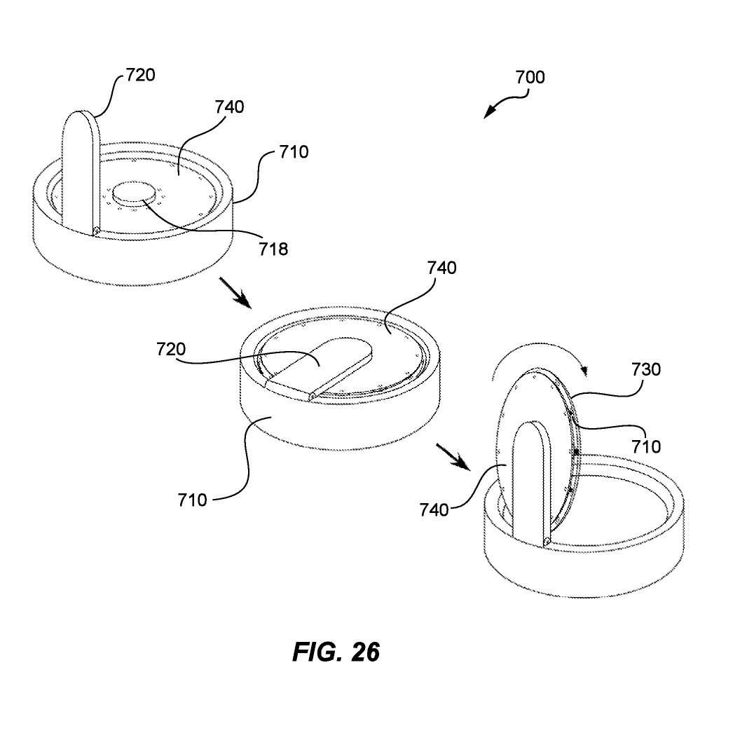

Illustrated in FIG. 26 is yet another representative embodiment 700 of the present invention, in which the basin enclosure 710 can include a rotation arm 720 which can rotate downwards prior to the hybridization step to attach to the top of the coupled upper clamp rotor 740 and lower carrier rotor 730. The rotation arm can then lift the coupled rotors 740, 730 as a together unit and rotate the assembly 90 degrees, so that the support axle 718 is aligned in a substantially horizontal plane and the hybridization units 710 rotate around the axle in a substantially vertical plane. Additionally, a small bubble of air or inert gas can be introduced into the reaction chambers of each hybridization unit, so that the rotation of the coupled rotors about the substantially horizontal support axle 718 causes gravity-induced bubble mixing to take place inside the reaction chamber during the hybridization/incubation step. Following the hybridization step, the rotation arm 720 can return the coupled rotors 740, 730 to a horizontal position so the wash steps can proceed as described above.

While the bubble-mixing embodiment 700 may be particularly useful for the semi-automated hybridization system 100 described above and illustrated in FIGS. 1-10, the bubble-mixing embodiment of the present invention may also be applicable to the substantially-automated hybridization system 400 described above and illustrated in FIGS. 11-22 as a complimentary or replacement mixing system to the pneumatic agitation system during incubation.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed is:

1. A unit for providing a reaction chamber on a slide comprising:
a slide substrate having a reaction area and a pair of exposed parallel edges for attachment to a carrier fixture of a processing device;
a chamber assembly removably coupled to the slide substrate to form a sealed reaction chamber enclosing the reaction area; and
an attachment means for coupling the chamber assembly to a clamp fixture of the processing device,
wherein separation of the clamp fixture from the carrier fixture removes the chamber assembly from the slide substrate to open the sealed reaction chamber.

2. The unit of claim 1, further comprising:
the chamber assembly comprising:
a flexible base layer having a top and bottom surfaces, the bottom surface forming a ceiling of the reaction chamber; and
a weakly-adhesive gasket seal extending from the bottom surface of the base layer to form sidewalls of the reaction chamber; and
the attachment means comprising a strongly-adhesive upper patch extending from the top surface of the base layer for attachment to the clamp fixture of the processing device.

3. The unit of claim 1, further comprising:
the chamber assembly comprising a domed shell having a flexible annular lip for forming a sealed reaction chamber enclosing the reaction area; and
the attachment means comprising a strongly-adhesive upper patch extending from the top surface of the dome for attachment to the clamp fixture of the processing device.

4. The unit of claim 1, wherein the attachment means comprises a set of chamber assembly borders extending beyond an additional pair of parallel edges of the slide substrate for coupling the chamber assembly to the clamp fixture of a processing device.

5. The unit of claim 4, wherein the pair of chamber assembly borders extend beyond the substrate edges parallel to a short axis of the slide substrate.

6. The unit of claim 4, wherein the pair of chamber assembly borders extend beyond the substrate edges parallel to a long axis of the slide substrate.

7. A system for a plurality of microarray slides comprising:
a basin enclosure;
a slide carrier rotor disposed on a support axle within the basin enclosure, for receiving at least one slide substrate therein;
a clamp rotor disposed on the support axle and adjacent the carrier rotor, for receiving at least one chamber assembly therein;
wherein engaging the clamp rotor with the carrier rotor couples the chamber assembly to the slide substrate to form at least one sealed reaction chamber; and
wherein disengaging the clamp rotor from the carrier rotor de-couples the chamber assembly from the slide substrate to unseal the at least one reaction chamber.

8. The system of claim 7, wherein the disposable chamber assembly comprises:
a flexible base layer having a top and bottom surfaces, the bottom surface forming a ceiling of the at least one reaction chamber;
a weakly-adherent gasket seal extending from the bottom surface of the base layer to form sidewalls of the at least one reaction chamber; and
a strongly-adhesive upper patch extending from the top surface of the base layer for attachment to the clamp fixture of the processing device.

9. The system of claim 7, wherein the chamber assembly comprises:
a domed shell having a flexible annular lip for forming the at least one sealed reaction chamber;
a flexible base layer having top and bottom surfaces;
an adhesive lower patch extending from the bottom surface for attaching the domed shell to the base layer; and
an adhesive upper patch extending from the top surface of the base layer for attachment to the clamp fixture of the processing device.

10. The system of claim 7, further comprising at least one manifold coupled to the exposed surface of the at least one disposable shell, wherein the manifold has at least one fill hole and at least one vent hole aligned with a fill port and a vent port in the disposable shell.

11. The system of claim 10, further comprising a valve rotor disposed on the support axle adjacent the clamp rotor and having at least one valve station with outwardly-projecting valve pins, wherein engaging the valve rotor with the clamp rotor causes the valve pins to removably plug the at least one fill hole and the at least one vent hole of the at least one manifold.

12. A method of processing a plurality of slides comprising:
inserting a plurality of slides into a processing device, each of the plurality of slides having a reaction area enclosed by a low-volume chamber assembly to form a low-volume reaction chamber;
filling the reaction chambers with a low-volume of fluid to react with the reaction areas;
removing the chamber assemblies from the plurality of slides to expose the reaction areas;
washing the plurality of slides in a common bath of wash fluid;
removing the plurality of slides from the common bath of wash fluid.

13. The method of claim 12, wherein the processing device further comprises at least one rotor disc disposed within a basin enclosure configured for containing the common bath of wash fluid.

14. The method of claim 13, wherein washing the plurality of slides further comprises submerging and rotating the at least one rotor disc in the common bath of wash fluid contained in the basin enclosure.

15. The method of claim 14, wherein removing the plurality of slides from the wash fluid further comprises separating the at least one rotor disc from the common bath of wash fluid and spinning the rotor disc to throw off the wash fluid.

16. A method of in-situ processing of a slide for the analysis of immobilized samples comprising:
obtaining a slide substrate having a reaction area containing immobilized samples;
mounting the slide substrate into a processing device for automated processing, the processing further comprising the steps of:
coupling a chamber assembly to the slide substrate to form a low-volume reaction chamber enclosing the reaction area;
filling the reaction chamber with fluid to react with the immobilized samples;
sealing the reaction chamber during incubation;
de-coupling the chamber assembly from the slide substrate to unseal the reaction chamber;
flushing the reaction area with a high volume of wash fluid to remove the reaction fluid; and
removing the wash fluid from the slide substrate; and
disengaging the slide substrate from the processing device.

17. The method of claim 16, wherein the low-volume reaction chamber holds less than about 100 μl of fluid.

18. The method of claim 16, wherein the chamber assembly further comprises an attached manifold having at least one fill hole and at least one vent hole aligned with a fill port and a vent port in the disposable chamber assembly to facilitate filling the reaction chamber with reaction fluid.

19. The method of claim 18, wherein sealing the reaction chamber further comprises removably plugging the at least one fill hole and the at least one vent hole with a plurality of valve pins.

20. The method of claim 16, further comprising agitating the reaction fluid by alternately inflating and deflating pneumatic bladders formed in the chamber assembly portion of the reaction chamber.

21. The method of claim 16, further comprising agitating the reaction fluid by introducing a gas bubble into the reaction chamber and rotating the slide substrate around a substantially horizontal axis.

22. The method of claim 16, further comprising heating the slide substrate to improve the reaction of the reaction fluid with the immobilized samples.

23. The method of claim 16, wherein the high volume of wash fluid further comprises of at least about 0.1 liters of wash fluid.

24. The method of claim 16, wherein removing the wash fluid further comprises utilizing centrifugal forces to spin the wash fluid off the slide substrate.

25. The method of claim 16, wherein removing the wash fluid further comprises blowing the wash fluid off the slide substrate with a stream of compressed gas.

26. The method of claim 16, further comprising simultaneously processing at least two slide substrates in the processing device, wherein the at least two slide substrates are flushed in a common volume of wash fluid.

27. A method of in-situ processing of at least two slides for the analysis of immobilized samples comprising:
obtaining at least two slide substrates having a reaction area containing immobilized samples;
coupling a chamber assembly to each slide substrate to form a low-volume reaction chamber enclosing the reaction area;
filling the reaction chambers with
reaction fluid to react with the immobilized samples;
mounting the at least two slide substrates into a processing device for processing, the processing further comprising the steps of:
sealing the reaction chamber during incubation;
agitating the hybridization fluid during incubation to increase the reactivity of the reaction fluid;
de-coupling the chamber assembly from the slide substrate to unseal the reaction chamber;
flushing the at least two slide substrates with a common wash fluid to remove the reaction fluids from the reaction areas; and
removing the wash fluid from the slide substrates; and
disengaging the at least two slide substrate from the processing device.

28. The method of claim 27, wherein the chamber assembly further comprises an attached manifold having at least one fill hole and at least one vent hole aligned with a fill port and a vent port in the chamber assembly to facilitate filling the reaction chamber with reaction fluid.

29. The method of claim 28, wherein sealing the reaction chamber further comprises removably plugging the at least one fill hole and the at least one vent hole with a plurality of valve pins.

30. A method of processing a plurality of slides comprising:
inserting a plurality of slides into a carrier fixture of a processing device, each of the plurality of slides having a reaction area containing immobilized reactants;
washing the plurality of slides in a common bath of wash fluid in accordance with a protocol;
removably coupling a plurality of disposable chamber assemblies to the plurality of slides to form sealed reaction chambers enclosing the reaction areas;
filling the reaction chambers with a low-volume of reaction solution to react with the enclosed reaction areas;
applying a clamp fixture to the chamber assemblies to further seal the reaction chambers during a reaction protocol;
lifting the clamp fixture to remove the chamber assemblies from the plurality of slides and expose the reaction areas;
washing the plurality of hybridization slides in a common bath of wash fluid in accordance with a protocol; and
removing the plurality of slides from the carrier fixture of the processing device.
